(19) United States
(12) Patent Application Publication
(10) Pub. No.: US 2013/0119723 A1
(43) Pub. Date: May 16, 2013

(54) VEHICLE SEAT

(71) Applicant: Kenichi Nitsuma, Tochigi (JP)

(72) Inventor: Kenichi Nitsuma, Tochigi (JP)

(73) Assignee: TS Tech Co., Ltd., Asaka-shi, Saitama (JP)

(21) Appl. No.: 13/811,128

(22) PCT Filed: Jul. 21, 2011
(86) PCT No.: PCT/JP2011/066618

§ 371 Date: Jan. 18, 2013

(30) Foreign Application Priority Data
Jul. 21, 2010 (JP) 2010-164342

(51) Int. Cl. B60N 2/427

(52) U.S. Cl. CPC B60N 2/427
USPC 297/216.13

(57) ABSTRACT

Provided is a vehicle seat that reliably enables effective reduction of the impact on the body, the cervical region, and the like of an occupant upon rear end collision, by causing the body to sink toward the vehicle rear side by an increased amount upon rear end collision. A vehicle seat S includes: a seat back frame including side frames, a pressure receiving member coupled to the seat back frame via coupling members to support an occupant, and an impact reduction member disposed on at least one of the side frames and coupled to the coupling members to cause the pressure receiving member to move rearward by a predetermined amount of impact load applied to the pressure receiving member; in which the seat back frame further includes a lumbar-sinking preventing member which prevents the movement such that the lumber of the occupant sinks rearward.

### CROSS REFERENCE TO RELATED APPLICATIONS

This application is the U.S. national phase of the International Patent Application No. PCT/JP2011/066618, filed Jul. 21, 2011, which claims the benefit of Japanese Patent Application No. JP2010-164342, filed Jul. 21, 2010, the entire content of all being incorporated herein by reference.

### BACKGROUND

Disclosed herein is a vehicle seat, specifically a vehicle seat with which a load on an occupant upon rear end collision is reduced.

Generally, there may be a case where the head of an occupant on a seat is suddenly caused to tilt rearward due to the inertia force and the cervical region is damaged upon a so-called rear end collision including a case where a part rearward of a vehicle seat of an automobile or the like is impacted from the rear side and a case where a part rearward the vehicle seat is severely impacted while a vehicle is traveling rearward, for example.

Accordingly, a vehicle seat in an automobile or the like conventionally has a headrest on a seat back for receiving the head of an occupant from behind, in order to protect the head, the cervical region, and the like, from the impact load upon rear end collision and to reduce the impact on the cervical region.

However, only with the headrest and without rapid reduction of a space between the occupant's head and the headrest upon rear end collision, it is, in some cases, difficult to sufficiently reduce an impact load on the cervical region, in addition to the fact that an impact load on the body cannot be reduced.

In order to solve such problems, a technique is known such that a seat back frame provided with a pressure receiving member for receiving the load of an occupant, in which a link member is disposed movably relative to side frames, the pressure receiving member is attached to a link member via coupling members, and upon rear end collision, the occupant is caused to sink sufficiently toward the seat back, effectively reduces an impact (refer to Japanese Patent Document No. 2009-023517, “the '517 Document”).

According to the seat back frame disclosed in the '517 Document, upon rear end collision, the pressure receiving member receives the rearward movement of the occupant. The link member pivots as a result to cause the occupant to sink toward the seat back frame. Further, a biasing element, which at all times suppresses the pivoting of the pressure receiving member, is attached to the link member. Therefore, the comfortable feeling when the occupant seats himself/herself will not be impaired.

In this way, the technique disclosed in the '517 Document enables reduction of the impact upon rear end collision by causing an occupant to sink rearward and by the pressure receiving member receiving the upper body of the occupant. However, there still remains a need to increase an amount of the body sinking (that is, to increase the movement amount of the occupant) toward the vehicle rear side. In other words, there still remains a need for a technique with which the impact reduction effect upon rear end collision is improved by further reliably and efficiently causing the upper body (specifically, the upper part of torso, the part from the cervical region to the vicinity of the breast region) of an occupant to sink.

### SUMMARY

It is an object of various embodiments of the present invention to provide a vehicle seat that enable effective reduction of the impact on the body, the cervical region, and the like, of the occupant upon rear end collision by efficiently causing the body to sink toward the vehicle rear side upon rear end collision.

The aforementioned problems are solved by a vehicle seat according to various embodiments of the present invention including: a seat back frame including side frames located on the sides thereof, a pressure receiving member coupled to the seat back frame via coupling members to support an occupant, and an impact reduction member disposed on at least one of the side frames and coupled to the coupling members to cause the pressure receiving member to move rearward by a predetermined amount of impact load applied to the pressure receiving member; in which the seat back frame further includes a lumbar-sinking preventing member which prevents the movement such that the lumber of the occupant sinks rearward.

In this way, a vehicle seat is configured such that, upon rear end collision, the body of an occupant is caused to sink rearward and the upper body of the occupant is received by the pressure receiving member. Further, the seat back frame includes the lumbar-sinking preventing member which prevents the movement causing the occupant's lumbar to sink rearward so that the lumbar is retained and stopped by the lumbar-sinking preventing member when the occupant is about to move rearward upon rear end collision.

As a result, in the upper body of the occupant, the lumbar (that is, the lower part of the torso) is retained and stopped by the lumbar-sinking preventing member without the rearward movement, while the part from the cervical region to the vicinity of the breast region (that is, the upper part of the torso) of the occupant is caused to move rearward so that the upper body of the occupant is tilted rearward. In this way, the movement amount of the upper part of the occupant's torso becomes larger than that of the lower part of the torso, so that the relative movement amount of the upper part of the torso becomes larger.

In the case where the vehicle seat without the lumbar-sinking preventing member and only including the pressure receiving member which is coupled to the link member, the upper body of the occupant is caused to move rearward without tilting rearward in the same body state as a state while the occupant normally seats himself/herself and thus caused to sink rearward together with the lumbar. Accordingly, for the same amount of load upon the rearward movement, in the case where the area where the occupant effect on the pressure receiving member (the area from the lumbar to the joint part of the cervical region) is large, the amount of rearward-sinking becomes relatively small compared to the case where the area the occupant affects is small.

According to various embodiments of the present invention including the lumbar-sinking preventing member, the area which operates to sink rearward is limited to the upper part of the occupant's torso so that the area becomes smaller and thus the amount of sinking in the vicinity of the cervical region becomes larger.

In this way, it is possible to efficiently cause the occupant to sink in a manner that the upper part of the occupant's torso is caused to sink toward the seat back by a large amount, which facilitates the occupant's head to abut against the headrest and thus reduces the load on the cervical region.

In this case, it is preferable for at least a part of the lumbar-sinking preventing member to be disposed forward relative to a front end of the pressure receiving member.

According to the vehicle seat of various embodiments of the present invention, the rearward movement of the pressure receiving member is started by the rearward movement of the occupant, and further the movement of the impact reduction member is started by the rearward movement of the pressure receiving member. Furthermore, the lumbar-sinking preventing member, which is configured such that at least a part of the lumbar-sinking preventing member extends forward relative to an end located forward most (that is, a front end) of the pressure receiving member, operates to stop the rearward movement of the lumbar of the occupant before the movement of the impact reduction member (before the sinking of the pressure receiving member).

In this way, the configuration in which the rearward movement of the occupant's lumber is retained and stopped by the lumbar-sinking preventing member before the movement of the impact reduction member is started by the rearward movement of the occupant causes the occupant to tilt rearward before the occupant is caused to move rearward. As a result, the occupant's torso is caused to tilt rearward by a large amount, so that the upper part of the torso is reliably caused to sink rearward. Therefore, the load on the cervical region may further be reduced.

In this case, it is preferable for at least a part of the lumbar-sinking preventing member to be disposed forward relative to at least a part of the impact reduction member.

The lumbar-sinking preventing member which stops the rearward movement of the occupant is configured such that the lumbar-sinking preventing member is disposed forward of at least a part of the impact reduction member, so that, upon the rearward movement of the occupant, the occupant is reliably caused to tilt rearward by the lumbar-sinking preventing member before the occupant is caused to sink rearward. As a result, the upper part of the torso is caused to move rearward by a large amount and further abutment of the occupant's head against the headrest is facilitated, so that an effect to reduce the load on the cervical region is improved.

Further, it is preferable for the pressure receiving member to be coupled to the seat back frame via an upper coupling member locked to the upper part thereof and a lower coupling member locked to the lower part thereof, for the upper coupling member and the lower coupling member to be formed by a flexible wire respectively, and for the wire configuring the upper coupling member to be formed thinner than the wire configuring the lower coupling member.

In this way, the coupling member disposed between the pressure receiving member and the side frame is configured by a flexible wire respectively so that, when the pressure receiving member receives the rearward load upon the rearward movement of the occupant, the wire curves (or the wire in a bent state stretches), and a further increased rearward movement amount of the pressure receiving member is achieved.

Further, the upper wire is formed thinner than the lower wire so that the upper wire curves easier (or the wire in a bent state stretches easier) than the lower wire. As a result, the upper part of the pressure receiving member moves rearward easier than the lower part thereof so that pivoting around the lower part (specifically, around a point to which the lower coupling member is locked) to tilt rearward is facilitated. Accordingly, upon the rearward movement of the occupant, the lumbar-sinking preventing member causes the occupant's torso to tilt rearward and the following rearward tilting movement (pivoting) of the pressure receiving member is facilitated so that the rearward tilting of the upper body of the occupant will not be prevented and the load on the cervical region is further reduced.

According to the aforementioned configuration in which the lower wire is formed thick, the lower wire is not easily deformed and the upper thin wire curves easily when the occupant normally seats himself/herself. Accordingly, the lower part of the pressure receiving member is not easily moved rearward and the upper part of the pressure receiving member allows a moderate amount of rearward movement when the occupant normally seats himself/herself, so that a comfortable feeling is additionally obtained when the occupant normally seats himself/herself.

In this case, it is preferable for the impact reduction member to be coupled to the lower coupling member.

As described above, when the occupant normally seats himself/herself, the pressure receiving member provided with the lower coupling member formed by a thick wire causes a small amount of the rearward sinking of the lower part of the pressure receiving member, so that the occupant's body is supported therewith. However, upon rear end collision, it is necessary also for the lower part of the pressure receiving member to sink like the upper part thereof. A large amount of the rearward sinking of the pressure receiving member may be achieved by a configuration in which the impact reduction member is attached to the thick wire forming the lower coupling member to move the impact reduction member.

Accordingly, upon rear end collision, a sufficient sinking amount of the whole part of the pressure receiving member is achieved when the occupant's torso is caused to tilt rearward by the lumbar-sinking preventing member. In other words, upon the rearward movement of the occupant due to rear end collision, the occupant's torso is caused to tilt rearward by the lumbar-sinking preventing member, and the rearward tilting of the occupant will not be prevented by the pressure receiving member. As a result, it is possible to ensure a sufficient amount of sinking in order to further reduce the load on the cervical region.

Provided herein is a vehicle seat which enables reduction of the load on an occupant's cervical region upon rear end collision by efficiently causing the upper part of the occupant's torso to sink toward the seat back.

According to an embodiment, the vehicle seat enables reduction of the load on the cervical region upon rear end collision, since the upper part of the occupant's torso may reliably be caused to move rearward (tilt rearward) and a large amount of rearward movement of the upper part of the occupant's torso may be achieved.

According to an embodiment, it is possible to provide the vehicle seat that enables further suppression of the load on the cervical region, since the rearward tilting movement of the occupant upon rear end collision is induced reliably.

According to an embodiment, provided is the vehicle seat such that, upon rear end collision, an increased amount of the rearward movement of the pressure receiving member upon rear end collision is achieved and a comfortable feeling is provided when the occupant normally seats himself/herself.

According to an embodiment, the vehicle seat enables reduction of the load on the cervical region, since a sufficient amount of sinking may be ensured without preventing the rearward tilting of the occupant.

### BRIEF DESCRIPTION OF THE DRAWINGS

FIG. 1 is a schematic perspective view of a seat according to a first embodiment of the present invention.

FIG. 2 is a schematic perspective view of the seat frame according to the first embodiment of the present invention.

FIG. 3 is an explanatory schematic cross sectional side view of a seat back frame before an impact reduction member pivots according to the first embodiment of the present invention.

FIG. 4 is an explanatory schematic cross sectional side view of the seat back frame after the impact reduction member pivots according to the first embodiment of the present invention.

FIG. 5 is an explanatory enlarged side view illustrating a relation between the impact reduction member and a side frame according to the first embodiment of the present invention.

FIG. 6 is an explanatory exploded view of the impact reduction member and a biasing element according to the first embodiment of the present invention.

FIG. 7 is an explanatory perspective view of the impact reduction member according to the first embodiment of the present invention.

FIG. 8 is an explanatory side view illustrating a state of the impact reduction member and the biasing element before/after rear end collision according to the first embodiment of the present invention.

FIG. 9 is a schematic perspective view of the seat back frame according to the first embodiment of the present invention.

FIG. 10 is a schematic perspective view of a lumbar-sinking preventing member according to the first embodiment of the present invention.

FIG. 11 is a schematic perspective view of the seat back frame according to a second embodiment of the present invention.

FIG. 12 is a schematic perspective view of the lumbar-sinking preventing member according to the second embodiment of the present invention.

FIG. 13 is a schematic perspective view of the seat back frame according to a third embodiment of the present invention.

FIG. 14 is a schematic perspective view of the seat back frame according to a fourth embodiment of the present invention.

FIGS. 15A, B are explanatory side views of the movement of an occupant according to a technique in the background art.

FIGS. 16A, B are explanatory side views of the movement of an occupant according to embodiments of the present invention.

### DETAILED DESCRIPTION

An embodiment of the present invention is described with reference to the drawings. The components, arrangements, and the like described below do not limit the scope of the invention and of course, may employ various modifications within the principle of the present invention. In this description, it is intended that the term “vehicle” includes the vehicles for traveling the ground with wheels such as automobiles, railroad trains, and the like, and the vehicles for transfer on which seats may be loaded such as aircraft, vessels, or the like traveling other than the ground. Further, a normal load upon being seated include an impact upon being seated, an acceleration load generated upon sudden acceleration of a vehicle and the like. The load upon rear end collision refers to a large amount of load generated by rear end collision including a severe vehicle crash from the rear side, a severe crash while a vehicle is traveling rearward, and the like; and does not include the load generated when an occupant normally seats himself/herself or the load generated in such a load area. Furthermore, the term “the upper part of the torso” refers to a part corresponding to the breast region.

Moreover, the horizontal direction refers to the horizontal direction relative to the vehicle front and corresponds to the width direction of a seat back frame 1 to be described later. The longitudinal direction refers to longitudinal direction in a state where an occupant seats himself/herself on a seat.

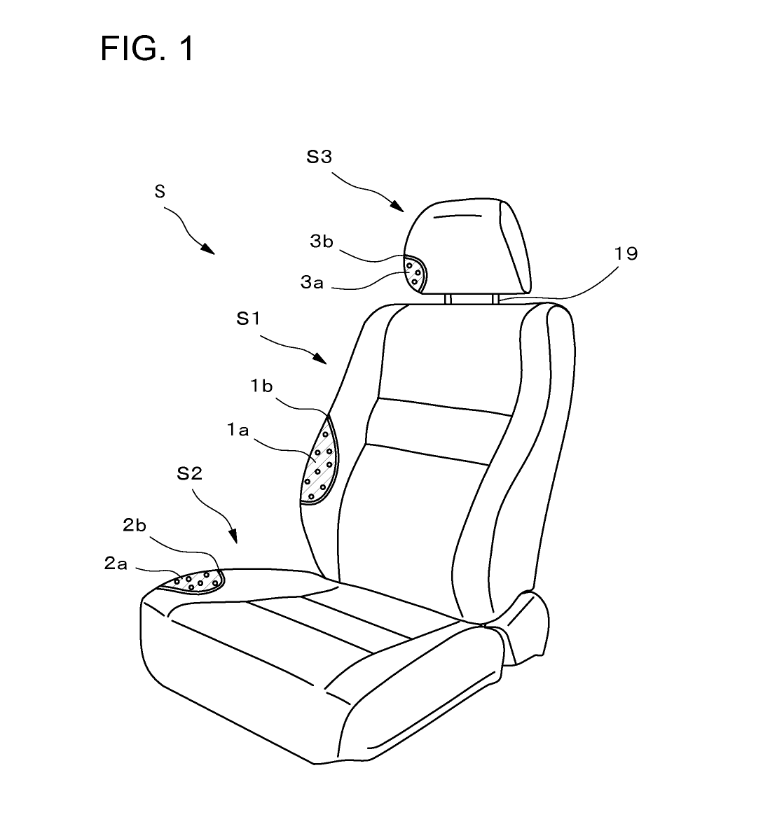

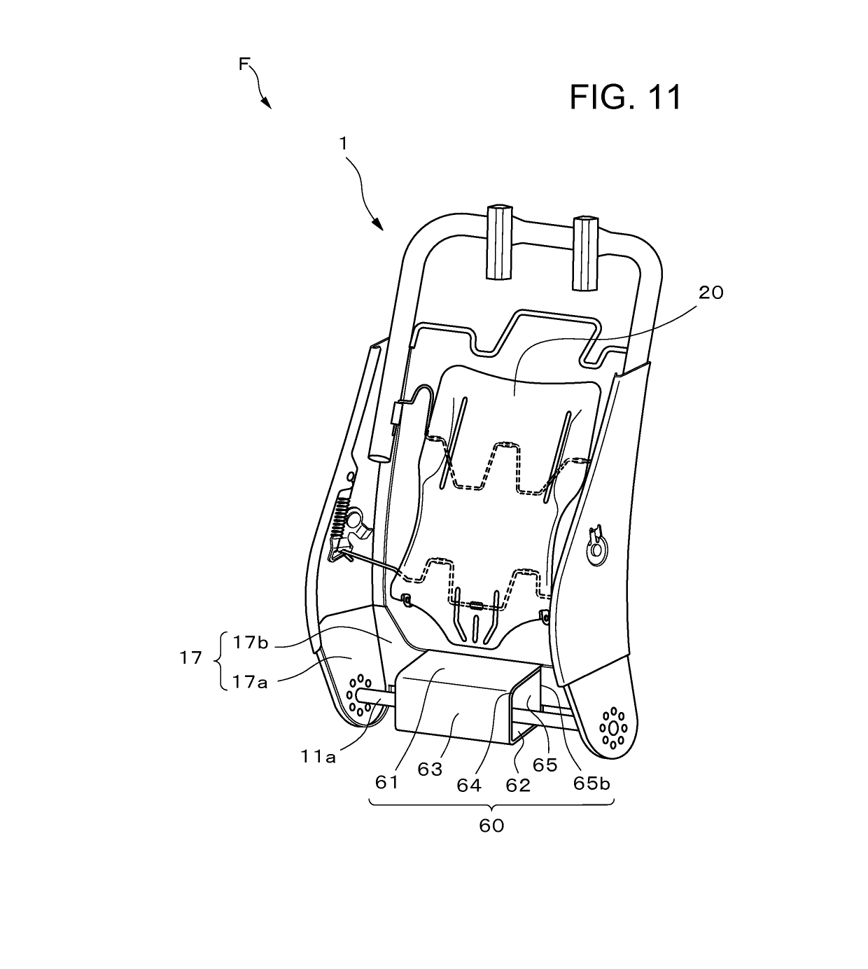

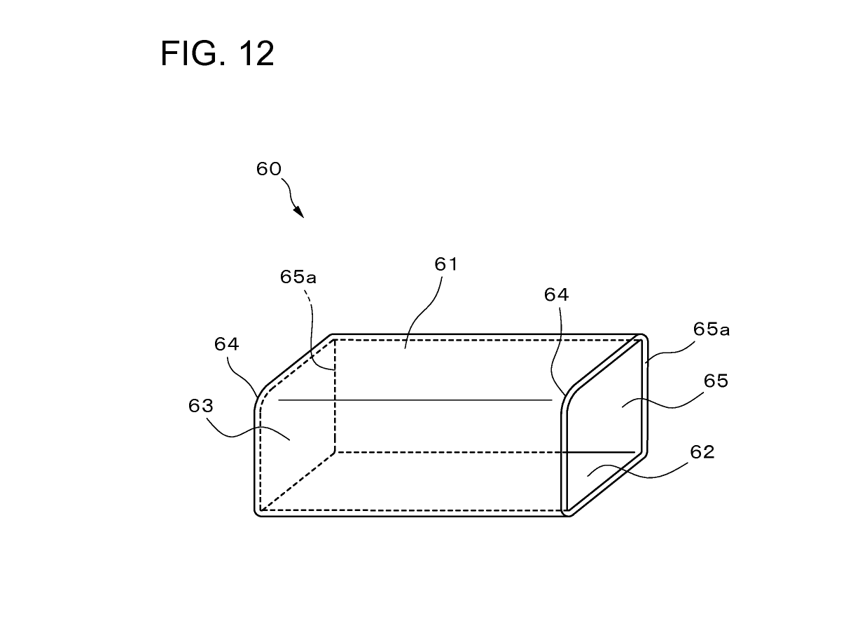

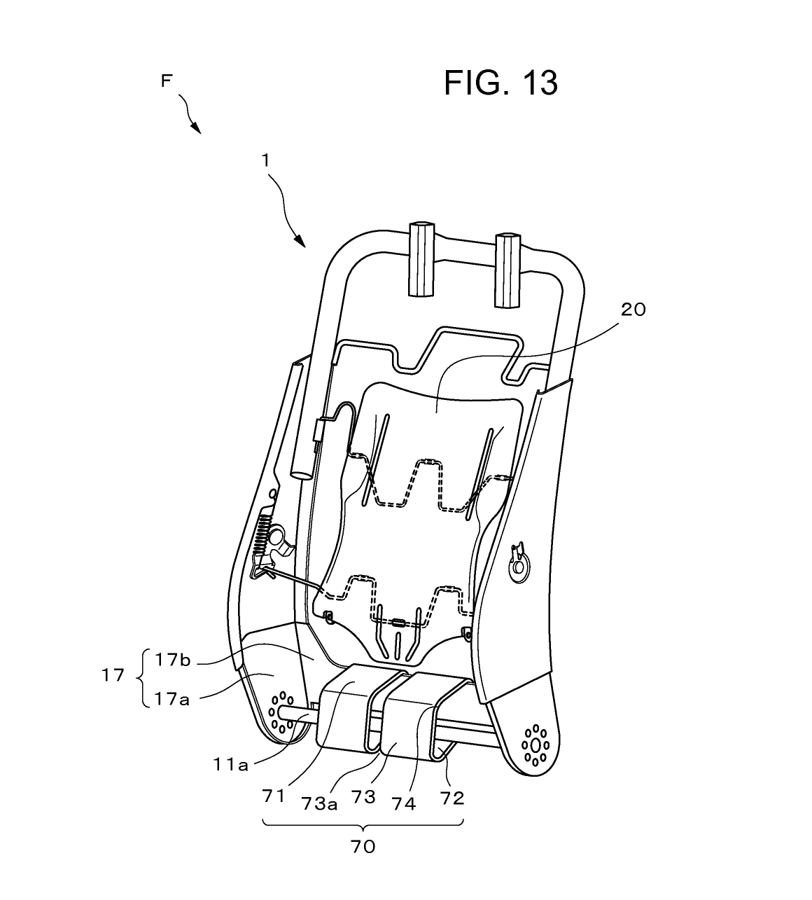

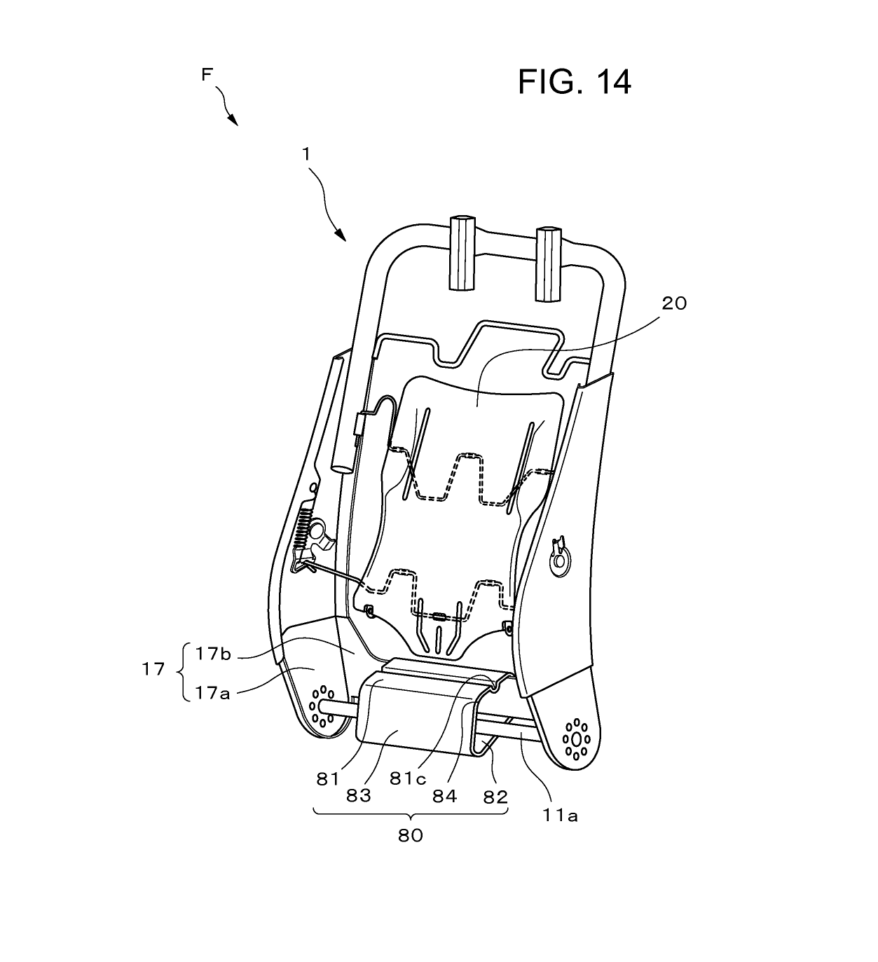

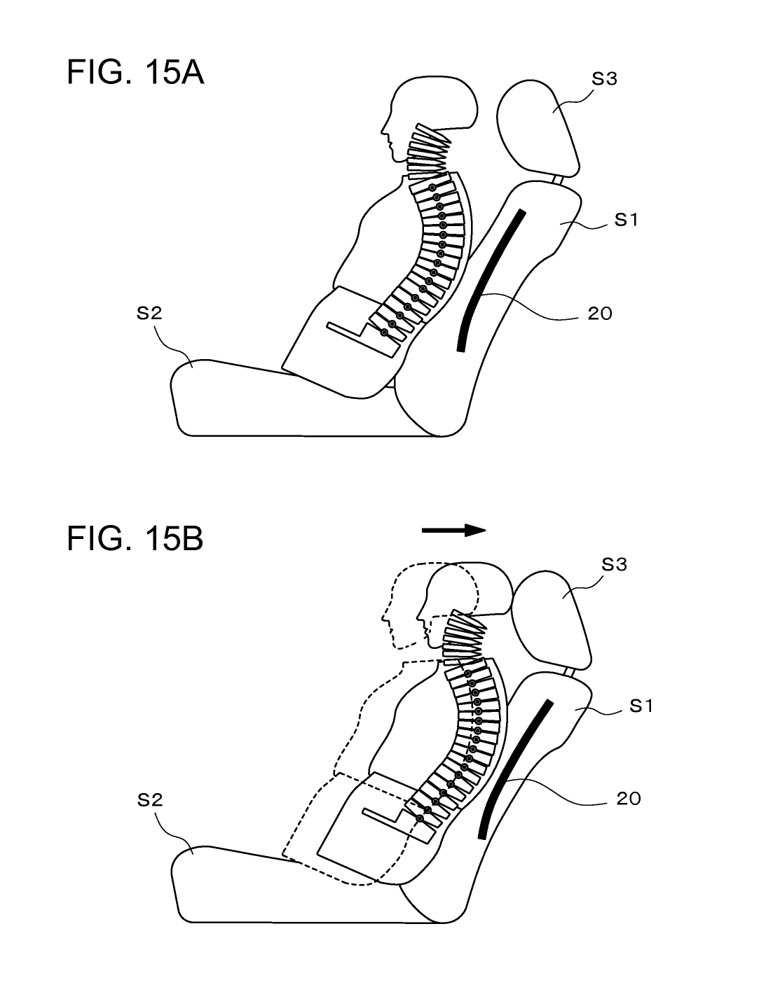

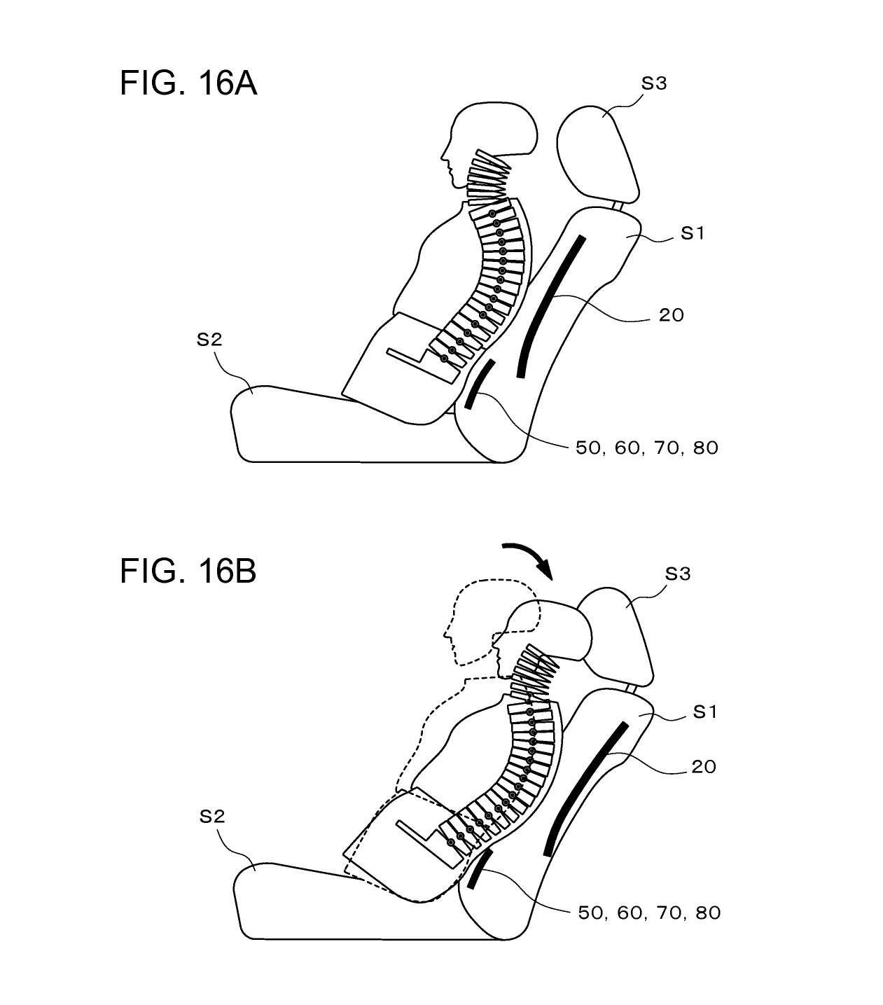

FIG. 1 through FIG. 10 relate to a first embodiment of the present invention. FIG. 11 and FIG. 12 relate to a second embodiment of the present invention. FIG. 13 relates to a third embodiment of the present invention. FIG. 14 relates to a fourth embodiment of the present invention and is a schematic perspective view of the seat back frame. FIGS. 15A and B relate to a technique in the background art and is an explanatory view of the movement of an occupant. FIGS. 16A and B are explanatory views of the movement of an occupant in embodiments of the present invention.

### First Embodiment

A vehicle seat S according to a first embodiment is described with reference to FIG. 1 through FIG. 10.

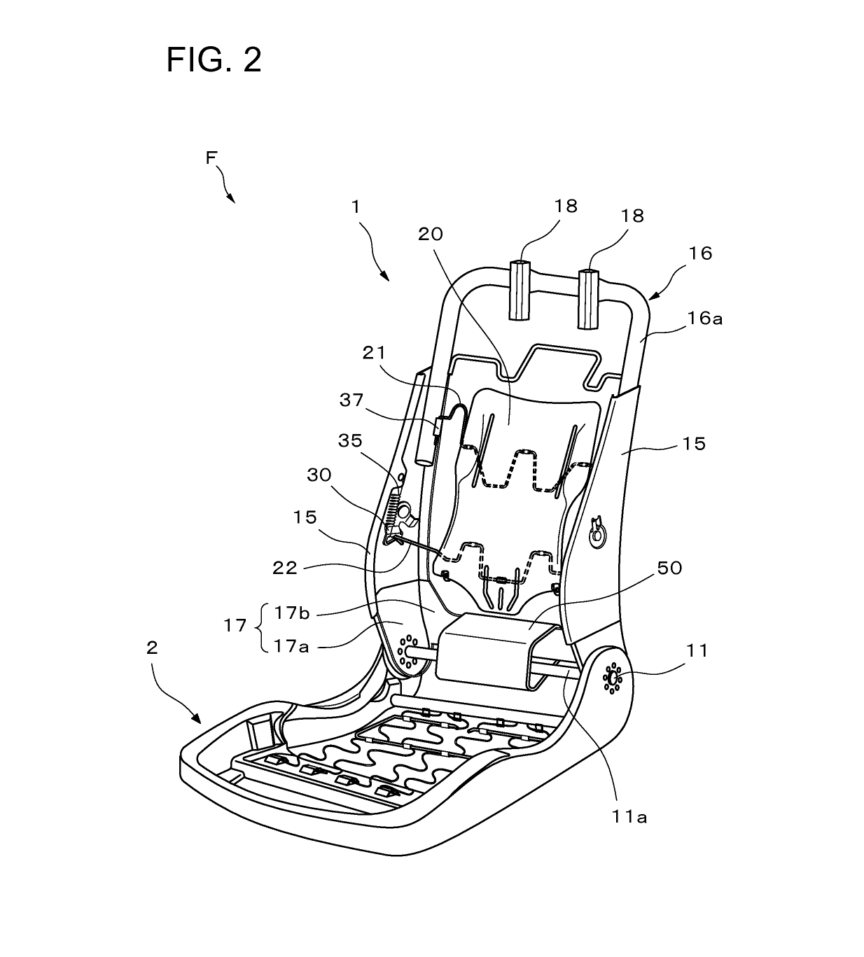

As illustrated in FIG. 1, the vehicle seat S is formed by a seat back S1 (back portion), a seat base S2, a headrest S3. The seat back S1 (back portion) and the seat base S2 are covered with outer layer materials 1b, 2b in a state where cushion pads 1a, 2a are mounted on a seat frame F (FIG. 2). A headrest S3 is formed by a pad material 3a disposed on a head frame (not illustrated) covered with an outer layer material 3b. A headrest pillar 19 supports the headrest S3.

As illustrated in FIG. 2, the seat frame F of the vehicle seat S is formed by a seat back frame 1 forming the seat back S1 and a seat base frame 2 forming the seat base S2.

As described above, the seat base frame 2 is configured such that a cushion pad 2a is mounted thereon and the cushion pad 2a is covered with an outer layer material 2, to support an occupant from below. The seat base frame 2 is supported by leg portions to which an inner rail (not illustrated) is attached respectively. The leg portions are assembled in a slidable manner between an outer rail disposed on a vehicle body floor in the longitudinal direction allowing place adjustment, respectively.

A rear end of the seat base frame 2 is coupled to the seat back frame 1 via a reclining mechanism 11.

The reclining mechanism 11 includes at least a reclining shaft 11a along the pivot shaft of the reclining mechanism 11. The reclining shaft 11a is disposed to be fitted into a hole (not illustrated) disposed in elongated portions 17a of a lower frame 17 and protrude through the side of the seat frame F.

The seat back S1 supports the back of the occupant from behind, in which the cushion pad 1a is mounted on the seat back frame 1 and the cushion pad 1a is covered with the outer layer material 1b as described above. As illustrated in FIG. 2, the seat back frame 1 is a generally rectangular-shaped frame including a side frame 15, and an upper frame 16, and a lower frame 17, in this embodiment.

Two side frames (a pair of side frames) 15 are disposed apart from each other in the horizontal direction to configure the width of the seat back and extend in the vertical direction. An upper frame 16 extends upward from the side frames 15 to couple each upper end of the side frames 15 to each other. Specifically, the upper frame 16 extends from one side frame 15, is bent, and then extends to the other side frame 15.

A lower frame 17 of the seat back frame 1 is formed to couple lower ends of the side frame 15 to each other. The lower frame 17 includes the elongated portions 17a coupled to the lower ends of the side frames 15 and elongated downward, and an intermediate portion 17b coupling both sides of the frame. The elongated portions 17a are elongated within a range not to interfere with the seat base frame 2.

Although in the seat back frame 1 according to this embodiment, the side frame 15, the upper frame 16, and the lower frame 17 are formed by separate members, they may be formed by an integrated pipe frame, an integrated plate frame, or the like. Further, a configuration may be employed in which a device such as an actuator (reclining motor) is arranged between the elongated portion 17a of the lower frame 17 and an end of a lumbar-sinking preventing member 50 to be described later.

In the lower frame 17, a lumbar-sinking preventing member 50 is further disposed as a cervical region load reduction element in a manner that a portion corresponding to the rear part of the lumbar of an occupant bulges toward the lumbar, that is, toward the front of the seat frame F. The lumbar-sinking preventing member 50 is anchor joined with the intermediate portion 17b of the lower frame 17 and designed in a hollow cylindrical or rectangular cylindrical shape. Into the hollow inside of the lumbar-sinking preventing member 50, the reclining shaft 11a is disposed in an inserted manner, so that movement (pivoting) of the reclining shaft 11a is not interfered with by the lumbar-sinking preventing member 50 abutting against the reclining shaft 11a.

In this way, the lumbar-sinking preventing member 50 further includes the reclining mechanism 11 disposed below the seat back frame 1, to be disposed in a bulged manner forward of the pivot shaft of the reclining mechanism 11. The specific configuration and operations of the lumbar-sinking preventing member 50 will be described later.

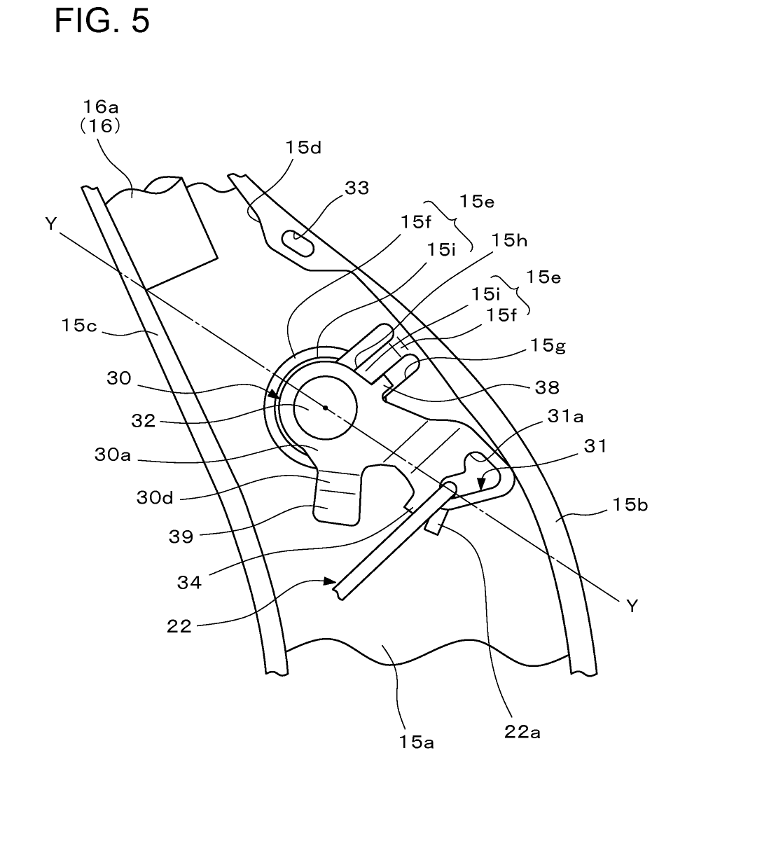

As shown in FIG. 2, the upper frame 16 formed by a member having a closed cross sectional shape (a circular cross section, a rectangular cross section, or the like) is bent in a generally U-shape. A side surface portion 16a of the upper frame 16 is disposed in a manner that a part thereof is overlapped with a side plate 15a of the side frame 15 in the vertical direction, to be anchor-joined to the side frame 15 at this overlapped part (refer to FIG. 5). Although the upper frame 16 is, in this first embodiment, formed by a tubular member having a circular cross section, a tubular member having a rectangular cross section may be employed.

The headrest S3 is disposed above the upper frame 16. The headrest S3 is configured such that the pad material 3a is disposed around the outer periphery of a core (not illustrated) and the outer periphery of the pad material 3a is covered with the outer layer material 3b, as described above. A pillar support portion 18 is disposed in the upper frame 16. The headrest pillar 19 (refer to FIG. 1) which supports the headrest S3 is attached to the pillar support portion 18 via a guide lock (not illustrated), so that the headrest S3 is attached thereto. Although an example in which the seat back S1 and the headrest S3 are separately formed is described in this first embodiment, a bucket type seat in which the seat back S1 and the headrest S3 are integrally formed may be employed.

As illustrated in FIG. 2, the side frame 15 configuring a part of the seat back frame 1 is an extension member which configures a side surface of the seat back frame 1, and includes a tabular side plate 15a, a front edge 15b bent inward in a U-shape from a front end (the end located on the vehicle front of the side plate 15a), a rear edge 15c bent inward in an L-shape from the rear end (refer to FIG. 5).

A protrusion portion 15d bulging toward the rear edge 15c is formed on the front edge 15b in this embodiment and on the protrusion portion 15d, a locking hole 33 as a locking portion for locking a spring is formed.

A notch which is notched toward the vehicle front with a reduced width may be formed from the protrusion portion 15d of the front edge 15b to a position where a tension coil spring 35 as a biasing element is disposed. This notch enables preventing the interference of the side frame 15 with the tension coil spring 35.

Further, a movement member 30, to be described later, is locked with the side frame 15 in the present embodiment. A configuration and operations of the movement member 30 will be described later in detail.

In the seat back frame 1 (between both side frames 15), a pressure receiving member 20 is disposed in an area inside the seat back frame 1 as a pressure receiving member which supports the cushion pad 1a from behind.

The pressure receiving member 20 in this embodiment is a member formed by a generally rectangular plate-shaped resin and on the surface of which abutting against the cushion pad 1a, a smooth concavo-convex shape is formed. As illustrated in FIG. 2, a claw which locks a wire 21 as an upper coupling member and a wire 22 as a lower coupling member is formed on the upper part and the lower part of the rear surface of the pressure receiving member 20, respectively.

The pressure receiving member 20 in this embodiment is supported by a coupling member. Specifically, the two wires 21, 22 as coupling members are bridged between both side frames 15 and engaged with the pressure receiving member 20 by the claw formed in a predetermined position on the upper part and lower part of the rear surface of the pressure receiving member 20 respectively, to support the pressure receiving member 20 on the rear surface of the cushion pad 1a. The wires 21, 22 are formed by elastic steel wire in which a winding portion as a bent portion, respectively.

The wire 21 located the upper of the two wires 21, 22 locked to the pressure receiving member 20 in this embodiment is configured by a wire thinner than the wire 22 located lower. Because of this configuration, rearward movement of the upper part of the pressure receiving member 20 is facilitated compared to the lower part thereof. Accordingly, when the rearward tilting of an occupant is induced by a lumbar-sinking preventing member 50, to be described later, movement of the pressure receiving member 20 along with the rearward tilting movement is facilitated so that the rearward tilting movement of the occupant is not prevented by the pressure receiving member 20. As a result, an increased amount of rearward movement of the occupant may be achieved.

The wire 22 is formed by a thick wire and thus has a high rigidity, i.e., not easily to be deformed when the occupant normally seats himself/herself. Accordingly, when the occupant normally seats himself/herself, rearward movement of the upper part of the pressure receiving member 20 supported by the wire 21 formed by a thin wire is facilitated, and a large amount of rearward movement of the lower part of the pressure receiving member 20 supported by the wire 22 formed by a thick wire is suppressed. As a result, since the upper part of the pressure receiving member 20 appropriately sinks rearward and the lower part thereof supports the occupant's body when the occupant normally seats himself/herself, the comfortable feeling upon being seated is not deteriorated.

Further, the wires 21, 22 are configured such that the winding portion thereof induces a large amount of deformation by a load equal to or more than a predetermined amount (a larger amount of load than that for movement or pivoting of the impact reduction member to be described later) so that a larger amount of rearward movement of the pressure receiving member 20 is achieved.

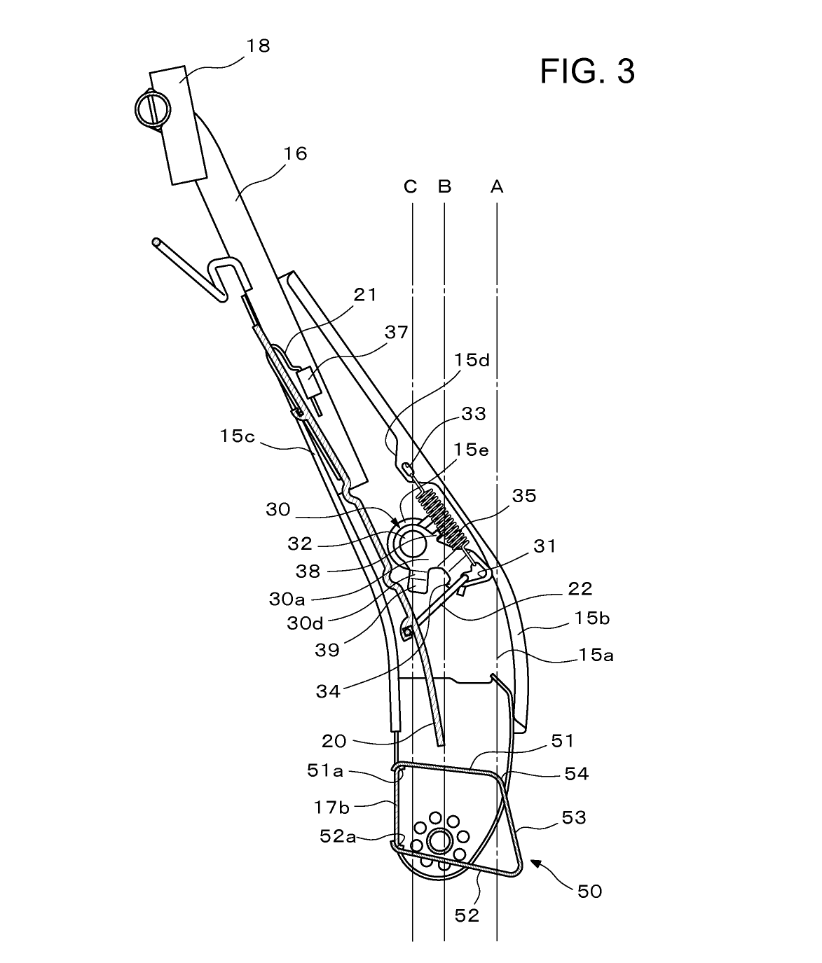

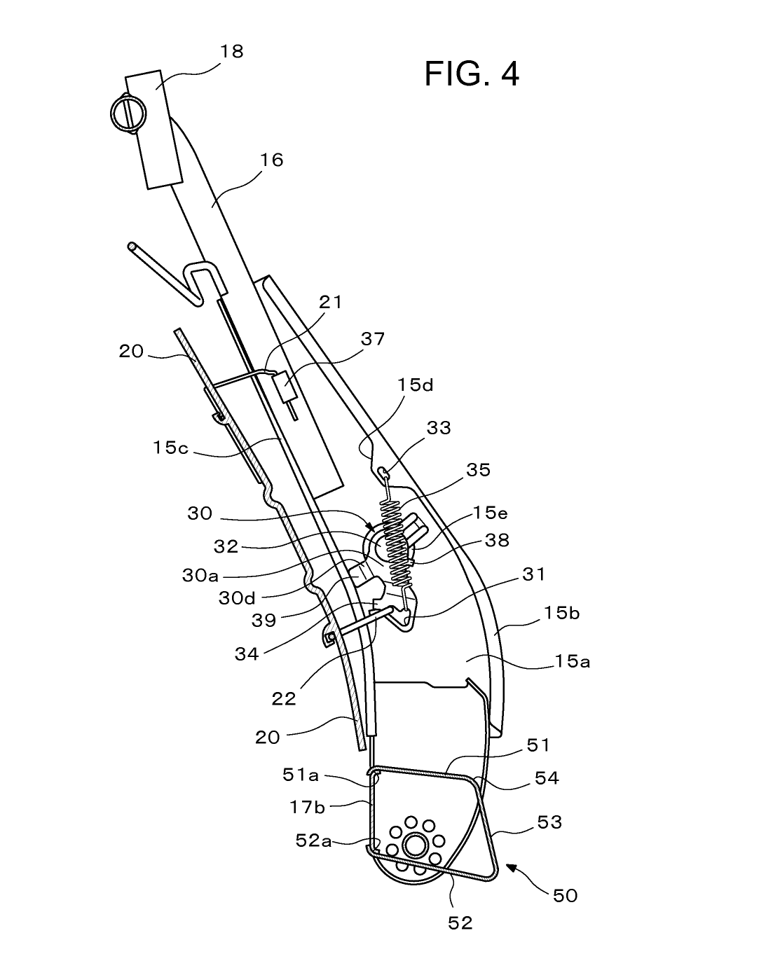

As illustrated in FIG. 3 and FIG. 4, in the two wires 21, 22 locked to the pressure receiving member 20 in this embodiment, both ends of the wire 21 locked to the upper part are hooked to a shaft supporting member 37 disposed to the both side frames 15, respectively. Both ends of the wire 22 locked to the lower part are hooked to a locking portion 31 of the movement member 30 attached to the right and left side frames 15, respectively.

The wire 22 which is formed by a thicker wire than the wire 21 is not easily deformed as described above, and thus the lower part of the pressure receiving member 20 is not easily moved rearward when the occupant normally seats himself/herself. Accordingly, the movement members 30 are attached to the ends of the wire 22 to ensure a sufficient amount of sinking upon rear end collision.

When the impact load equal to or more than a predetermined amount due to rear end collision or the like is applied to the pressure receiving member 20, the movement member 30 as an impact reduction member is moved rearward by the impact load transferred via the coupling member (the wire 22) and causes the pressure receiving member 20 to move rearward to move an occupant rearward. The term “movement” refers to a horizontal movement, pivoting, or the like. In this embodiment, the movement member 30 is described which pivots around a shaft 32 as a pivot shaft. When the movement member 30 is moved toward the vehicle rearward, a large amount of movement toward the vehicle rearward of the pressure receiving member 20 may be achieved. Accordingly, the impact on an occupant may be reduced by the rearward movement of the occupant.

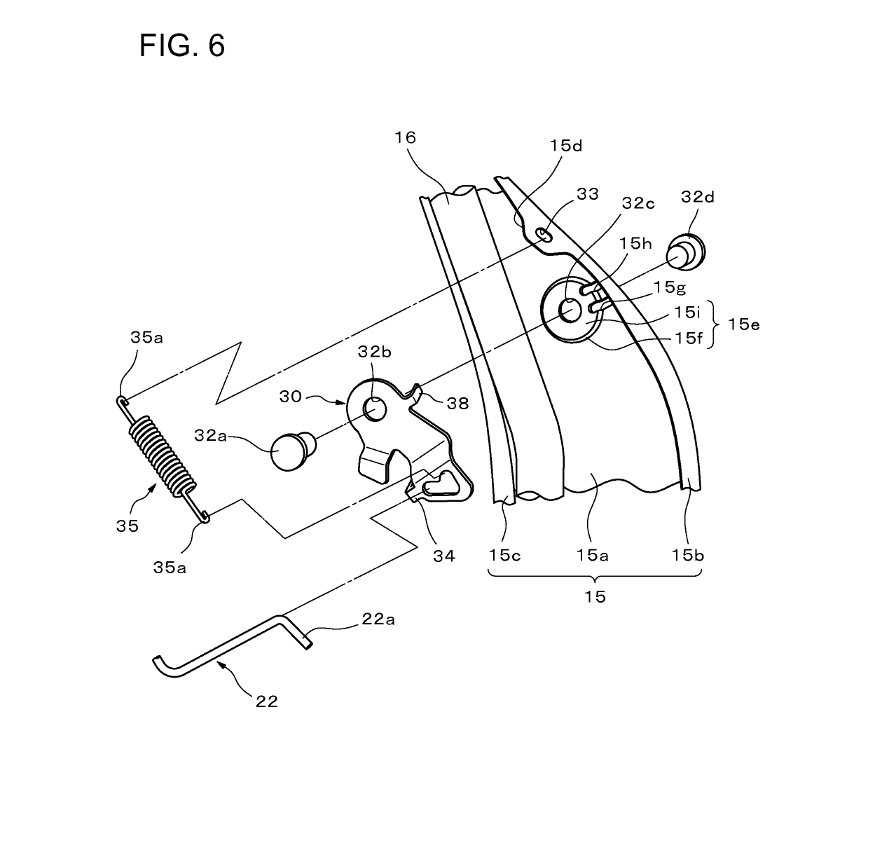

As illustrated in FIG. 5 and FIG. 6, the movement member 30 in this embodiment is pivotably supported on the inside of each side plate 15a of the both side frames 15 via the shaft 32 as a pivot shaft, to lock the wire 22 as a coupling member at the lower part and be coupled to a spring (a tension coil spring 35) as a biasing element which biases the wire 22. In other words, the movement member 30 is configured to be coupled to the biasing element 35 to bias the pressure receiving member 20 toward the front side of the seat back frame 1 via the coupling member 22 (the tension coil spring 35 is omitted in FIG. 5 for the sake of illustration).

Further, the movement member 30 in this embodiment is disposed inside the side frame 15 via the pivotable shaft 32.

As illustrated in FIG. 6, the shaft 32 is configured by a shaft member 32a, a shaft hole 32b formed on the movement member 30, a hole portion 32c formed on the side plate 15a of the side frame 15, and a fitting member 32d in which the shaft member 32a is inserted through the shaft hole 32b and latched into the hole portion 32c, the fitting member 32d is fitted thereinto from the end-side of the shaft member 32a, to pivotably support the movement member 30. On the side plate 15a of the side frame 15, a convex portion 15e is formed which bulges toward inside the position where the shaft 32 is disposed, specifically, the movement (pivot) range of the shaft 32.

The movement member 30 in this embodiment includes the pivotable shaft 32, the locking portion 31 of the coupling member formed at a position separated from the shaft 32 by a predetermined distance, the locking portion (a locking concave portion 31a) of the biasing element, and a movement preventing portion 39 for preventing movement (pivoting).

Into the locking portion 31 for locking the coupling member (the wire 22) in this embodiment in a hooked manner, a bent hook end (a hook portion 22a) of the wire 22 as a coupling member is inserted. The locking portion 31 is formed as an elongated hole for facilitating the attachment of the hook portion 22a. Further, a locking concave portion 31a for locking the biasing element (the tension coil spring 35), to be described later, is integrally formed with the locking portion 31 in a continuous manner.

A formation portion 30c of the locking portion 31 is formed to peripherally extend from a raised portion 30b which is formed in a raised manner on the outer peripheral side of a base portion 30a configuring the movement member 30. The first raised portion 30b is formed at a position approximately 90° separated from the movement preventing portion 39 around the shaft 32.

In the wire 22 hooked to the locking portion 31, a hook portion 22a is formed by an end thereof inserted into the locking portion 31. The hook portion 22a enables a configuration such that upon the movement (pivoting) of the movement member 30, the wire 22 is not easily detached from the movement member 30 even if a large amount of load is applied to the wire 22.

In order to further prevent the detachment of the wire 22 from the movement member 30, a pivoting suppression portion 34 having a hook shape is disposed, in the formation portion 30c on which a locking portion 31 of the movement member 30 is formed, to protrude at the vehicle rearward relative to the locking portion 31.

A pivoting suppression portion 34 is a protruded piece which extends from the formation portion 30c and is formed in an integral manner with the formation portion 30c. The protruded piece is bent toward the side an end of the wire 22 (the hook portion 22a) is disposed. Accordingly, in the case where upon rear end collision or the like, the movement member 30 moves (pivots), the load toward the vehicle rear-side is applied to the wire 22, and then the wire 22 is rotated, the pivoting suppression portion 34 abuts against the hook portion 22a.

In this way, the pivoting suppression portion 34 is formed at a position where abutment against an end of the wire 22 inserted from the seat inside toward the side frame 15 is easily achieved, to prevent detachment of the wire 22.

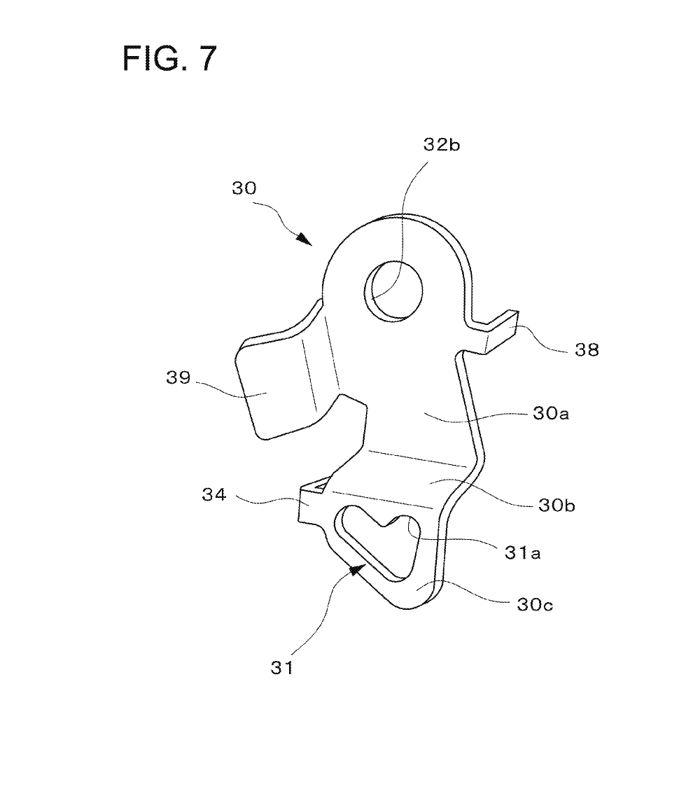

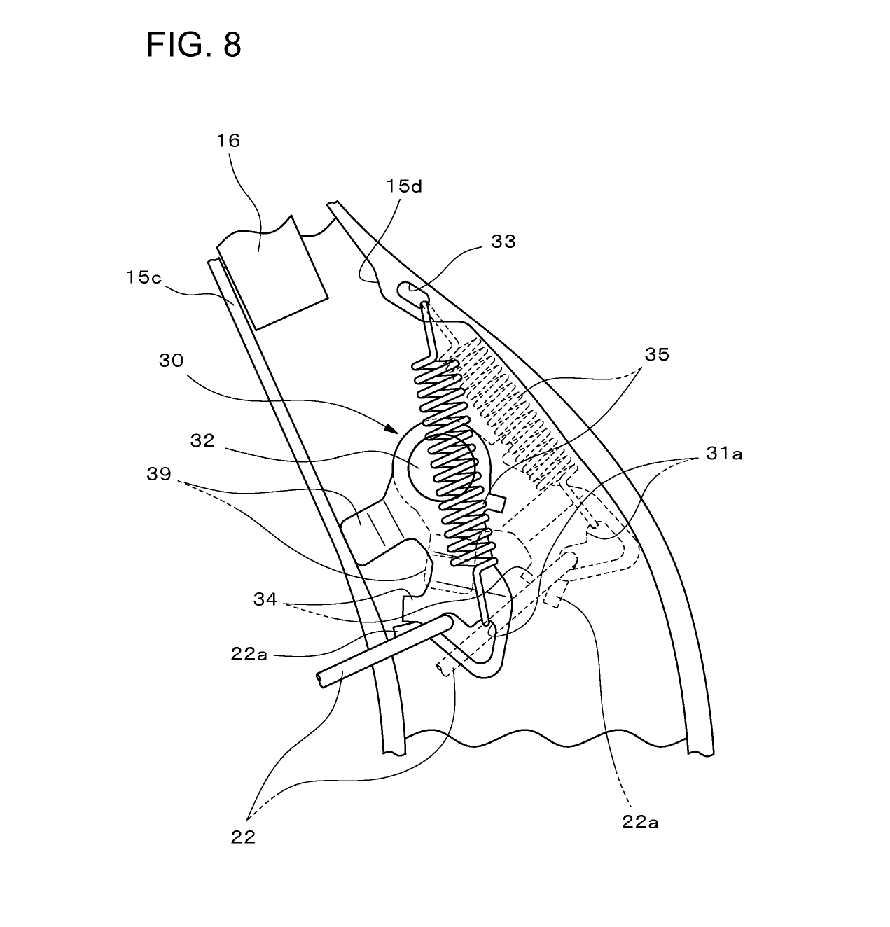

As illustrated in FIG. 7, the pivoting suppression portion 34 is formed by an anchored protruded piece extending from the formation portion 30c. The protruded piece is formed substabtially perpendicular to the side frames 15. Further, as illustrated in FIG. 8, the pivoting suppression portion 34 is configured to be engaged with the hook portion 22a of the wire 22 and prevent rotation of the wire 22 upon the movement (pivoting) of the movement member 30.

In other words, the pivoting suppression portion 34 is formed in the direction where the hook portion 22a rotates upon movement (pivoting) of the movement member 30, relative to the hook portion 22a.

When the rearward load is applied to the wire 22 upon rear end collision, the movement member 30 moves (pivots) rearward. At this time, there may be a risk where the rearward tension is applied to the wire 22, the wire 22 is rotated, and then the hook end 22a is detached from the locking portion 31 formed in an elongated hole. However, embodimens of the present invention enable suppressing the rotation of the wire 22 so that the detachment of the wire 22 from the locking portion 31 of the movement member 30 is prevented, with a configuration in which the pivoting suppression portion 34 is formed in the direction where the hook portion 22a of wire 22 rotates upon the movement (pivoting) of the movement member 30 to the hook portion 22a is engaged with the pivoting suppression portion 34.

A locking concave portion 31a of the biasing element in this embodiment locks an end of the tension coil spring 35 as a biasing element. The locking concave portion 31a is formed by notching a part of the locking portion 31 toward the vehicle rear side in the formation portion 30c where the aforementioned locking portion 31 is formed. As illustrated in FIG. 5, the locking concave portion 31a is formed at a position in the vehicle forward relative to the line Y connecting the center of the shaft 32 and the positions where the wire 22 is hooked to the locking portion 31. For the sake of illustration, the tension coil spring 35 is omitted in FIG. 5.

As illustrated in FIG. 6, the tension coil spring 35 as a biasing element in this embodiment is formed by a spring wire being coil-shaped. A hook 35a is formed both ends of the tension coil spring 35 in a semicircular shape, respectively. Further, the hook 35a of the tension coil spring 35 is locked to the locking concave portion 31a of the movement member 30 and the locking hole 33 in the protrusion portion 15d of the side frame 15. The configuration causes the tension coil spring 35 to bias the movement member 30 toward the forward of the seat back frame 1 (refer to FIG. 8).

The aforementioned movement member 30 is attached to both side frames 15 in a manner that each of the hook portions 22a as both ends of the wire 22 is hooked to the locking portion 31 in the movement member 30 of the both side frames so that each movement member 30 independently operates from each other.

The movement member 30 attached to the both side frames 15 in this embodiment is configured such that the movement member 30 attached to both sides thereof moves (pivots) independently from each other. Accordingly, in the case where uneven load is generated, the movement member 30 attached to each side of the side frames 15 moves (pivots) independently from each other in accordance with the load so that the occupant's body is caused to sink in accordance with an impact load amount.

When the occupant normally seats himself/herself, a tension which causes the movement member 30 to move (pivot) rearward via the cushion pad 1a in the seat back S1, the pressure receiving member 20, and the wire 22 is generated, while the tension coil spring 35 biases the movement member 30 to be moved (pivoted) toward the front side of the seat back frame 1. In this case, since the tension coil spring 35 coupled to the movement member 30 has a load characteristic not to be deflected within a load range generated when the occupant normally seats himself/herself, the movement member 30 is held in a default position at all times. In other words, the movement member 30 is configured such that the strongest force causing the movement member 30 to return to the default state against a force causing the movement member 30 to move (pivot) is achieved when the occupant normally seats himself/herself.

A protruded piece 38 is integrally formed with the movement member 30 for controlling the movement (pivot) range due to the biasing force of the tension coil spring 35. As illustrated in FIG. 5, the protruded piece 38 is formed by a part protruding from the base portion 30a toward the outer periphery of the base portion 30a which slidably contacts with the convex portion 15e formed in the side plate 15a. A perpendicular surface of the protruded piece 38 to the base portion 30a is bent toward the seat outside, that is, toward the side plate 15a of the side frame 15. Further, in the movement member 30, the protruded piece 38 with the aforementioned configuration is formed in the vehicle forward relative to the position the shaft 32 is disposed.

The protruded piece 38 is configured to abut against and engage with the convex portion 15e of the side frame 15 from the lower side thereof. Accordingly, an upward force applied to the movement member 30 may be resisted by a biasing force of the tension coil spring 35.

A slope portion 15f is a sloped surface formed to rise from the side plate 15a of the side frame 15 toward the seat inside. The slope portion 15f configures the convex portion 15e together with a planar portion 15i.

Further, the slope portion 15f is continuously formed from a part where the movement member 30 makes a slidable contact to the front edge 15b of the side frame 15. Although the slope portion 15f extends to the front edge 15b in this embodiment, a configuration in which the slope portion 15f extends to the rear edge 15c may be employed. Specifically, in the side frame 15, the slope portion 15f is formed in a generally circular shape in the planar view at a position which surrounds the shaft 32 and the base portion 30a disposed around the shaft 32, in which a part of the slope portion 15f extends toward the front edge 15b or the rear edge 15c.

The slope portion 15f is formed at a portion with a high rigidity of the front edge 15b, the rear edge 15c, or the like. A protruded piece 38 abuts against the convex portion 15e which extends toward the front edge 15b or the rear edge 15c. Accordingly, since the protruded piece 38 abuts against the convex portion 15e with a high rigidity, a deformation is prevented even if a large amount of load is applied due to rear end collision.

A stopper portion 15g is formed by notching a part of the convex portion 15e (specifically, a part of the slope portion 15f) into an elongate hole. The stopper portion 15g facilitates the engagement of an end of the protruded piece 38 therewith so that the case where the protruded piece 38 ride on the convex portion 15e is prevented even if an upward force is applied to the protruded piece 38 by the tension coil spring 35. An open end of the anchor-shaped protruded piece 38 is formed to be in the same plane as the side plate 15a, instead of a configuration in which the protruded piece 38 is fitted into the stopper portion 15g.

Further, each hole portion 15h is formed at position facing the stopper portion 15g as elongated holes with a predetermined space therebetween. The hole portion 15h is formed in a generally same shape and same size as the stopper portion 15g, and the long axis of the elongated hole is formed to be parallel to the long axis direction of the stopper portion 15g.

The hole portion 15h facilitates formation of the convex portion 15e (specifically, the slope portion 15f, the planar portion 15i) to which the movement member 30 is attached. Further, the side frame 15 of which a part is notched realizes the vehicle seat S with a reduced weight.

The planar portion 15i which forms the convex portion 15e is formed to be generally orthogonal to the movement range (the pivot axis) of the movement member 30. Accordingly, a configuration is achieved in which a large abutment area of the convex portion 15e to the planar-shaped base portion 30a is obtained. As a result, since a large amount of frictional force is generated upon the slide-contact between the planar portion 15i and the base portion 30a, an operation of the movement member 30 as a stopper portion upon movement (pivoting) is enhanced, which facilitates control of the movement (pivot) range of the movement member 30. Further, the slide contact between the planar portion 15i and the base portion 30a enables a stable movement (pivot) of the movement member 30 relative to the side frame 15.

The movement preventing portion 39 in this embodiment prevents the movement (pivot) of the movement member 30 upon the movement (pivot) thereof. As illustrated in FIG. 3 and FIG. 4, a second raised portion 30d is formed by a part protruded from the base portion 30a in a continuous manner in the outer periphery side of the base portion 30a which makes a slide-contact with the convex portion 15e formed on the side plate 15a upon pivoting around the shaft 32. Further, the movement preventing portion 39 is formed by a perpendicular surface extending outside the pivot shaft (the shaft 32) to the second raised portion 30d. The movement preventing portion 39 in the aforementioned configuration is formed in the vehicle rearward relative to the position where the shaft 32 is disposed.

The second raised portion 30d is formed to rise in a generally perpendicular to the direction separated from the side plate 15a, that is, perpendicular to the base portion 30a; the movement preventing portion 39 configured by a surface generally perpendicular to the second raised portion 30d is formed generally parallel to the side plate 15a of the side frame 15. The movement preventing portion 39 abuts against the rear edge 15c of the side frame 15 so that the movement (pivot) range of the movement member 30 is regulated.

As illustrated in FIG. 5, the second raised portion 30d forms a bent portion which is bent and rises parallel to the rear edge 15c of the side frame 15 and in the direction separated from the side plate 15a. Further, the movement preventing portion 39 is continuous from the bent portion and bent perpendicular to the rear edge 15c.

The movement preventing portion 39 is a contact portion where, after the movement (pivoting) of the movement member 30, the movement (pivoting) is prevented by abutment against the rear edge 15c of the side frame 15, respectively. Further, the surface in the thick direction of the movement preventing portion 39 abutting against the side frame 15 after the movement (pivoting) of the movement member 30 is formed to be flush with the rear edge 15c upon the abutment.

The movement preventing portion 39 is disposed to regulate the set range of movement (pivot) of the movement member 30. The movement preventing portion 39 is set so that, when the load of the occupant causes the movement member 30 to move (pivot) upon rear end collision, the movement preventing portion 39 abuts against the upper frame 16 and the movement is stopped. In other words, the movement preventing portion 39 which sets the stop position of the movement member 30 after movement (pivot) is formed.

In this way, the movement preventing portion 39 of the movement member 30 is formed integrally with the movement member 30 by extending the movement member 30 in the outer peripheral direction, and a contact portion thereof makes an abutment against the side frame 15 after movement (pivot). It enables reliably and stably stopping the movement (pivoting) of the movement member 30 with a reduced number of components and a simple configuration with an ensured strength.

The movement preventing portion 39 is formed at a position where the movement preventing portion 39 does not interfere with the biasing element (the tension coil spring 35) or the coupling member (the wire 22) to be described later.

This embodiment is configured such that the movement preventing portion 39 of the movement member 30 directly abuts against the side frame 15 to prevent the movement (pivoting) thereof. However, between the movement preventing portion 39 and the side frame 15, a sound-deadening member such as a rubber element having a thickness not to interfere with a stable movement (pivot) stop of the movement member 30 may be attached to deaden the sound caused upon abutment. This configuration enables a stable preventing of a movement (pivoting) as well as a sound-deadening effect.

As described above, the movement member 30 according to embodiments of the present invention includes the protruded piece 38 and the movement preventing portion 39 to control the movement (pivot) range of the movement member 30. The movement of the movement member 30 upon rear end collision is described below with reference to the drawings.

FIG. 3 illustrates the impact reduction member before pivoting, FIG. 4 illustrates the impact reduction member after pivoting, FIG. 5 illustrates a relation between the impact reduction member before pivoting and the side frame, and FIG. 8 illustrates a state before rear end collision with a dashed line and a state after rear end collision with a solid line. The protruded piece 38 abuts against the convex portion 15e at all times at the position where the stopper portion 15g arranged on the side frame 15, to resist an upward force applied by the tension coil spring 35 and thus to limit the movement (pivot) range of the movement member 30 in a manner that an excessive forward movement (pivoting) of the movement member 30 is prevented.

Upon rear end collision, as illustrated in FIG. 8, when the impact from behind causes the occupant to move rearward because of the inertia, the load causes the tension in the direction where the movement member 30 is caused to move (pivot) rearward (the left side of FIG. 8) via the pressure receiving member 20 (not illustrated in FIG. 8) and the wire 22 locked to the pressure receiving member 20. The tension at this time provides a sufficient load to cause the tension coil spring 35 holding the movement member 30 at a default position to stretch and move (pivot) the movement member 30 rearward.

A threshold for a force by which the movement member 30 begins to move (pivot) is set greater than the load generated when an occupant normally seats himself/herself.

It is preferable for the threshold for a force by which the movement member 30 begins to move (pivot) to be greater than 150N since the load on the seat back S1 in a state where an occupant normally seats himself/herself (except small impacts caused by seating, sudden acceleration of the vehicle, or the like) is about 150N. A smaller value than this is not preferable since movement is caused even when the occupant normally seats himself/herself, which lacks stability.

Further, in view of the impact when the occupant normally seats himself/herself and the load upon acceleration caused by the sudden acceleration or the like, it is preferable for the threshold value to be set larger than 250N. This enables the movement member 30 to be in a stable state except for the operation upon rear end collision.

As described above, the rearward movement (pivot) of the movement member 30 causes the wire 22 which is hooked to the locking portion 31 to move rearward and accordingly causes the pressure receiving member 20 locked to the wire 22 and the cushion pad 1a supported by the pressure receiving member 20 to move rearward, to cause the occupant to sink into the seat back S1.

Now, movement (pivot) characteristics of the movement member 30 upon rear end collision is described below in more detail with reference to FIG. 8.

At the default position of the movement member 30 before its movement (pivot), the locking portion 31 which locks the wire 22 and the locking concave portion 31a which locks the lower end of the tension coil spring 35 are disposed in the vehicle forward relative to the shaft 32. The upper end of the tension coil spring 35 is locked to the locking hole 33 formed at protrusion portion 15d of the side frame 15 located in the upper part of the movement member 30.

When a tension greater than a predetermined value is applied to the wire 22 due to rear end collision and then the movement member 30 begins to move (pivot) against the tension coil spring 35, the tension coil spring 35 stretches and the locking concave portion 31a disposed in the movement member 30 moves rearward while pivoting around the pivot center of the shaft 32. As illustrated in FIG. 8, the movement member 30 moves (pivots) until the movement preventing portion 39 abuts against the side frame 15 and the movement (pivoting) of the movement member 30 is prevented. This causes a great amount of movement of the pressure receiving member 20 toward the rearward of the seat frame 1 from the state illustrated in FIG. 3 to the state illustrated in FIG. 4, and an increased amount of sinking is achieved.

This embodiment is configured such that, since the upper end of the tension coil spring 35 is anchored to the locking hole 33 formed upper than the movement member 30 at the time when the movement member 30 moves (pivots) and the pressure receiving member 20 moves, the movement direction of the locking concave portion 31a and the stretching direction of the tension coil spring 35 are different to each other.

In other words, this embodiment is configured such that the movement (pivot) amount of the movement member 30 and the tension load (flex amount) of the tension coil spring 35 is not proportional to each other. In still other words, the pivot angle of the movement member 30 and the torque (rotation force) due to the tension coil spring 35 in the forward pivot direction are not simply parallel to each other.

Specifically, the locking concave portion 31a which locks the lower end of the tension coil spring 35 follows an arc-shaped locus around the shaft 32, while the locking hole 33 which locks the upper end of the tension coil spring 35 is formed as an anchored end which is anchor joined above the movement member 30.

The movement member 30 may reliably cause the occupant to sink into the cushion pad of the seat back 51 upon rear end collision efficiently, due to the aforementioned characteristics to the tension generated via the wire 22.

At this time, although the occupant's back is caused to sink into the seat back S1 and thus move rearward, the relative position of the headrest S3 is not changed. Accordingly, a space between the headrest S3 and the occupant's head is reduced and the occupant's head may be supported by the headrest S3 so that the impact on the cervical region may effectively be reduced.

Although the aforementioned embodiment is an example in which the movement member 30 is arranged on the side frame 15 on both right and left sides respectively, a configuration in which the movement member 30 is arranged on only one of the side frames 15 may be employed. In this case, the other side frame 15 without the movement member 30 may be configured to directly lock the coupling member (the wire) 21, 22.

In this way, the vehicle seat S according to various embodiments of the present invention, in which the movement member 30 as an impact reduction member is disposed in the side frame 15, may cause the occupant's body to sink rearward upon rear end collision. Further, the vehicle seat S includes a lumbar-sinking preventing member 50 for facilitating the rearward sinking of the occupant's body.

As described above, at a portion corresponding to the lumbar rearward position of the lower frame 17, the lumbar-sinking preventing member 50 is provided. The lumbar-sinking preventing member 50, which is formed to bulge toward the occupant's lumbar, is disposed to retain and stop the occupant's lumbar when the occupant is suddenly caused to move rearward upon rear end collision or the like.

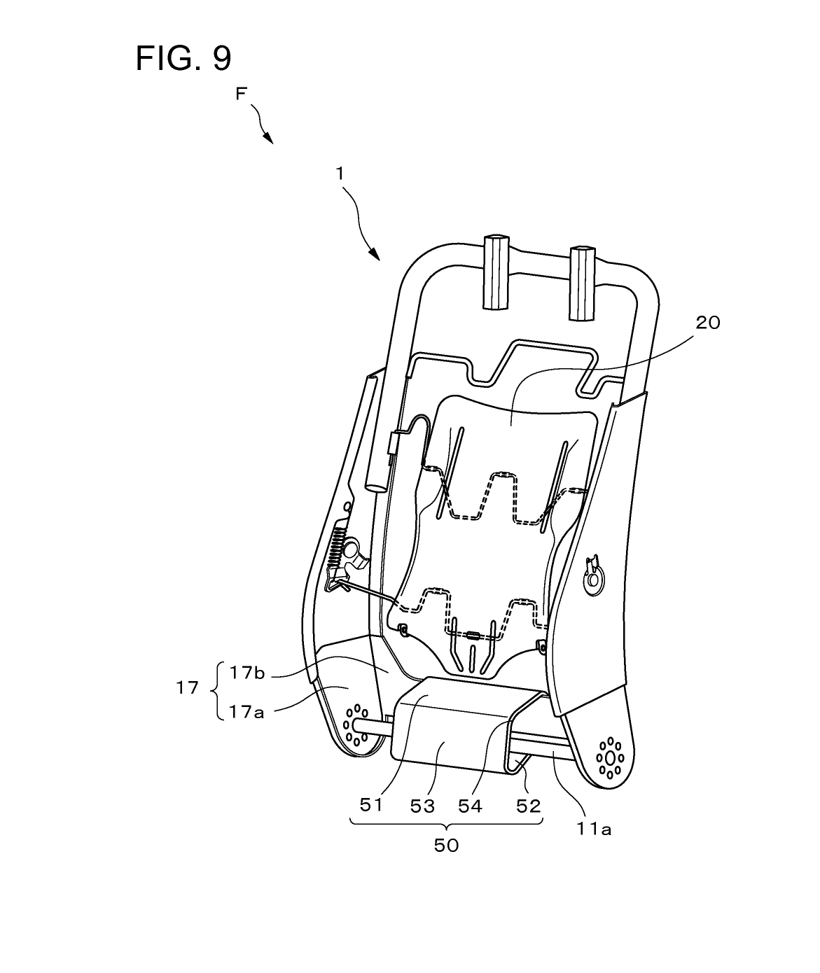

As illustrated in FIG. 9, the lumbar-sinking preventing member 50 is formed into a hollow rectangular column into which the reclining shaft 11a is inserted.

In this way, the lumbar-sinking preventing member 50, which is provided forward the position corresponding to the pivot shaft, that is, the reclining shaft 11a of the reclining mechanism 11, enables further rapid abutment of the occupant's lumber against the lumbar-sinking preventing member 50 upon rearward movement of the occupant.

A cushion material (the cushion pad 1a) is disposed on the lumbar-sinking preventing member 50, and the lumbar-sinking preventing member 50 is disposed at the position corresponding to the occupant's lumber via the cushion pad 1a and the outer layer material 1b. The lumbar-sinking preventing member 50 bulging forward in this way stops the movement of the occupant's lumber sinking into the seat back S1 via the cushion pad 1a and the outer layer material 1b. Accordingly, the movement is induced in which, upon rear end collision, the occupant's upper body sinks toward the seat back S1 while the occupant's whole upper body is tilted (pivoted) rearward. As a result, a sudden rearward movement of the head may be prevented.

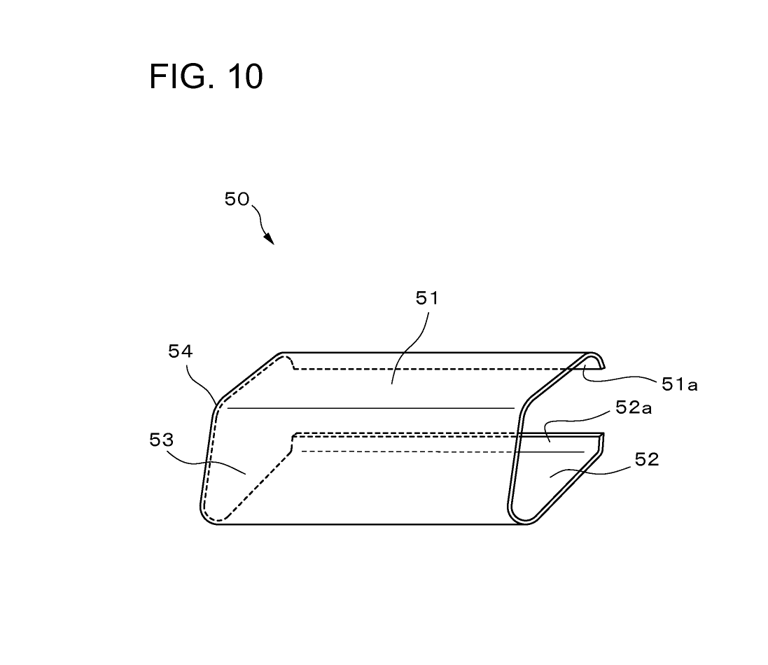

A joint method of the lumbar-sinking preventing member 50 and the lower frame 17 according to the first embodiment and a configuration of the lumbar-sinking preventing member 50 are described below in detail with reference to FIG. 3, FIG. 4, FIG. 9, and FIG. 10.

As illustrated in FIG. 9, the lumbar-sinking preventing member 50 is jointed to the lower frame 17 to protrude toward the front of the seat back frame 1, that is, the side where the occupant seats himself/herself. In this case, the reclining shaft 11a is disposed to pass through the inside of the lumbar-sinking preventing member 50, and disposed at a position free from abutment against the lumbar-sinking preventing member 50. Accordingly, the reclining shaft 11a pivots without interference by the lumbar-sinking preventing member 50 so that its reclining operation is not deteriorated.

In the first embodiment, the lumbar-sinking preventing member 50 is formed into a hollow, generally rectangular column shape a part of the side surface of which is notched as illustrated in FIG. 10. The lumbar-sinking preventing member 50 is jointed to the lower frame 17 in a manner that an upper surface 51 is disposed on the upper side, a lower surface 52 is disposed on the lower side, and a front surface 53 is disposed toward the front side of the seat frame F (the seat back frame 1), that is, toward the side where the occupant seats himself/herself. The upper surface 51 and the lower surface 52 include an upper contact portion 51a and a lower contact portion 52a each jointed to the lower frame 17, respectively. The upper contact portion 51a and the lower contact portion 52a is formed by an end of the upper surface 51 being bent downward and an end of the lower surface 52 being bent upward, respectively.

The upper contact portion 51a is jointed to the upper end of the lower frame 17 (specifically, the upper end of the intermediate portion 17b) in an overlapping manner, and the lower contact portion 52a is jointed (surface-jointed) to the lower end of the lower frame 17 (specifically, the lower end of the intermediate portion 17b). In this case, the upper surface 51 and the lower surface 52 are anchor-joined in a manner that the intermediate portion 17b is overlapped with the respective portions of the upper contact portion 51a and the lower contact portion 52a which are bent toward the front side of the seat frame F. Exemplary elements of anchor joint include welding, rivet joint, bolt joint, spot welding, and the like.

The first embodiment employs a configuration in which the upper contact portion 51a and the lower contact portion 52a having a shape formed by the ends of the upper surface 51 and the lower surface 52, which are bent respectively, are overlapped on the upper end and the lower end of the intermediate portion 17b, respectively. However, the shape in which the ends of the upper surface 51 and the lower surface 52 of the lumber-sinking preventing member 50 are bent respectively is not necessary. The ends or edges of the upper surface 51 and the lower surface 52 may directly be jointed to the surface of the intermediate portion 17b.

In this way, the strength of the surface joint is enhanced by forming joint surfaces on the lumbar-sinking preventing member 50 and jointing the ends of the lower frame 17 to these two joint surfaces in an overlapped manner. This configuration enables the lumbar-sinking preventing member 50 as well as the upper ends of the lower frame 17 to receive a load, especially a load from the upward direction, resulting in the vehicle seat S provided with the lumbar-sinking preventing member 50 with an enhanced strength.

A corner 54, which is formed at an interface between the upper surface 51 and the front surface 53, is formed in a smooth bulged-curved shape (arc shape) bulging upward. This configuration facilitates the rearward tilting of the occupant. Since the corner 54 is a portion to stop the occupant's lumbar sinking rearward upon rear end collision, it is preferable for the arc thereof to be designed having a large radius for reliably inducing the rearward tilting of the occupant.

The attachment order of the aforementioned lumbar-sinking preventing member 50 is not specifically defined. After the lumber-sinking preventing member 50 is jointed with the lower frame 17 and formed into an integrated member therewith, the reclining shaft 11a may be inserted into the hollow part of the lumbar-sinking preventing member 50, to assemble the seat frame F. Further, after the seat frame F is assembled by coupling the seat back frame 1 to the seat base frame 2 via the reclining mechanism 11, the lumbar-sinking preventing member 50 may be fit into and jointed with the lower frame 17 from the front side of the seat frame F.

A configuration in which the lumbar-sinking preventing member 50 is disposed at generally center part of the intermediate portion 17b enables the use of a certain (single) size of the lumbar-sinking preventing member 50, which may deal with various size of the seat back frame 1, and thus provides a broad utility. In other words, regardless of the size of the seat back frame 1, only a single size of the lumbar-sinking preventing member 50 may be formed for a sufficient operation as long as it can be sized and disposed in a manner that the occupant's lumbar is supported therewith.

The lumbar-sinking preventing member 50 is jointed in the longitudinal direction to the intermediate portion 17b of the lower frame 17. The horizontal length of the lumbar-sinking preventing member 50 is adapted in a manner that the right and left ends thereof may be disposed separated from the side frame 15 by a predetermined distance (specifically, the elongated portion 17a at both sides of the lower frame 17), respectively. This configuration is preferable in that a member such as an actuator (reclining motor) may be disposed between the lumbar-sinking preventing member 50 and the elongated portion 17a at both sides of the lower frame 17.

The effects due to the lumbar-sinking preventing member 50 disposed slightly separated from the inside of the right and left elongated portion 17a is described below.

According to the seat back frame 1 of various embodiments of the present invention, the occupant's lumbar is caused to move rearward, but retained and stopped by the lumbar-sinking preventing member 50, upon rear end collision. In the case where the lumbar-sinking preventing member 50 is disposed in a continuous manner to the elongated portion 17a of the lower frame 17, the impact from the occupant is transferred to the side frame 15 via the elongated portion 17a. As a result, the seat back frame 1 is caused to tilt rearward together with the lumbar-sinking preventing member 50, which makes it difficult to cause the occupant to sink into the pressure receiving member 20 disposed inside the seat back frame 1 by a sufficient amount.

The lumbar-sinking preventing member 50 disposed slightly separated from the inside of the elongated portion 17a enables a reduced amount of the impact which is transferred to the side frames 15 upon rear end collision even if the occupant's lumbar suddenly moves rearward.

Accordingly, it is possible to prevent the rearward tilting of the seat back frame 1, cause the upper body of the occupant to sink rearward by a sufficient amount, and thus reduce the load on the cervical region of the occupant.

As illustrated in FIG. 3, FIG. 4, FIG. 9, and FIG. 10, the lumbar-sinking preventing member 50 is formed into a hollow rectangular column a part of which side surface is notched, and the side surface is formed into a skewed generally squared U shape.

This hollow shape suppresses the sinking of the occupant's lumber. In addition, particularly when the side frame 15, the elongated portion 17a, or the like are inwardly deformed due to the load from the side upon lateral collision (the load upon lateral collision), the right and left elongated portions 17a abuts against the side end of the lumbar-sinking preventing member 50, respectively.

As illustrated in FIG. 3 and FIG. 4, it is preferable for the lumbar-sinking preventing member 50 to include at least a front surface 53 disposed forward, and for the lower part of the front surface 53 to be bulged forward relative to the upper part of the front surface 53. In other words, it is preferable for the front surface 53 of the lumbar-sinking preventing member 50 to be formed in a bulged manner forward relative to the position of the corner 54 (line A in FIG. 3). In this way, the configuration in which the lower part of the front surface 53 is tilted forward facilitates the upper body of the occupant to tilt rearward upon rear end collision, compared to the case where the lumbar-sinking preventing member 50 of which the front surface 53 is not tilted. As a result, the rearward pivoting of the upper body is facilitated and the sinking into the pressure receiving member 20 is facilitated, so that the load on the cervical region of the occupant is reduced.

Further, it is preferable for at least a part of the lumbar-sinking preventing member 50 of the vehicle seat S according to various embodiments of the present invention to be disposed in a bulged manner relative to the front end of the pressure receiving member 20 disposed between the side frames 15. In other words, the upper surface 51 or the front surface 53 is formed to extend forward relative to the front end (the line B in FIG. 3) located at the front most of the pressure receiving member 20. In this way, the configuration in which the lumbar-sinking preventing member 50 is bulged forward relative to the pressure receiving member 20 for receiving the body (back) of the occupant causes the occupant's back to sink into the pressure receiving member 20, which enables the occupant's lumber to abut against the lumbar-sinking preventing member 50 earlier than the timing of the movement (pivoting) of the movement member 30. As a result, it is possible to, upon rear end collision, make the timing of the rearward tilting (rearward sinking) earlier and make the sinking amount of the occupant larger, so that the load on the cervical region is reduced.

Further, at least a part of the lumbar-sinking preventing member 50, that is, the upper surface 51 or the front surface 53 is disposed forward at least a part of the movement member 30. Specifically, it is formed to extend forward the shaft 32 of the movement member 30, more specifically, forward the shaft member 32a and the fitting member 32d (line C in FIG. 3) of the shaft 32. In this way, a part of the lumbar-sinking preventing member formed forward the shaft 32 of the movement member 30 reliably induces, upon the rearward movement of the occupant, the rearward tilting of the occupant and thus enables an increased amount of the rearward movement of the occupant.

Upon sinking of the occupant's lumber part, this configuration enables the occupant's upper body to tilt rearward with an increased amount of the rearward movement of the occupant's body (the upper part relative to the lumbar, the upper part in the torso), and thus enables an increased amount of sinking into the pressure receiving member 20. Accordingly, it is possible to induce the cervical region and the head moving together with the upper body.

The lumbar-sinking preventing member 50 is formed by a plate metal with a predetermined thickness. The metal used in this case has a strength and hardness which may withstand the load upon rear end collision. Of course, other materials may be employed to configure the lumbar-sinking preventing member 50, as long as they provide a preferable anchor joint with the lower frame 17 and the strength beyond the load generated by the occupant when the impact is applied from the vehicle rearward.

The plate thickness, material, or the like may appropriately be selected to adjust the strength of the lumbar-sinking preventing member 50. For example, an increased plate thickness of the lumbar-sinking preventing member 50 may prevent the sinking of the lumbar even if the occupant's lumbar is caused to violently move rearward upon rear end collision, due to the lumbar-sinking preventing member 50 having a sufficient strength.

### Second Embodiment

A joint method of the lumbar-sinking preventing member 60 and the lower frame 17, and a configuration of the lumbar-sinking preventing member 60, are described below according to a second embodiment, with reference to FIG. 11 and FIG. 12.

A lumbar-sinking preventing member 60 according to the second embodiment is characterized by a rear surface 65, different from the lumbar-sinking preventing member 50 according to the first embodiment a part of which rear surface is notched. A configuration and operations other than a configuration of the lumbar-sinking preventing member 60 and an attachment method to the lower frame 17 (for example, the configuration related with the movement member 30) are the same as that of the lumbar-sinking preventing member 50 according to the first embodiment, and thus the explanation thereof are omitted.

In the second embodiment, the lumbar-sinking preventing member 60 is formed into a hollow generally rectangular column as illustrated in FIG. 11. The lumbar-sinking preventing member 60 is jointed to the lower frame 17 in a manner that an upper surface 61 is disposed as upper side thereof, a lower surface 62 is disposed as lower side thereof, a front surface 63 is disposed forward in the seat frame F (the seat back frame 1), and a rear surface 65 is disposed rearward in the seat frame F.

Although the lower frame 17 is fitted into the notched part in the first embodiment, in the second embodiment, a part of the intermediate portion 17b of the lower frame 17 is cut out and replaced in a manner that the cut surface of the intermediate portion 17b is jointed with a part or a whole part of the edge end (the side of the side surface) 65a of the rear surface 65. In other words, the lumbar-sinking preventing member 60 is shaped integrally with the intermediate portion 17b of the lower frame 17.

Although the case where a part of the edge end 65a (refer to FIG. 12) is jointed is illustrated in FIG. 11, in the case where the whole part of the edge end 65a is jointed with the cut surface of the intermediate portion 17b, the shape of the lumbar-sinking preventing member 60 or the shape of the intermediate portion 17b is altered for adjustment in a manner that the lumbar-sinking preventing member 60 does not abut against the reclining shaft 11a. The shape of the lower frame 17 may be altered instead.

It is preferable for the intermediate portion 17b to be jointed in a manner that a part which is bent forward the seat frame F and the upper surface 61 are integrally formed, since the joint strength of the rear contact portion 65b is enhanced.

Similar to the first embodiment, a corner 64 which is formed by the upper surface 61 and the front surface 63 is formed into a smooth bulged curve (arc shape) bulging upward.

In the second embodiment, the surface of the front surface 63 is formed in generally perpendicualr direction and the front surface 63 is formed generally parallel to the lower frame 17. However, a configuration in which the front surface 63 of the lumbar-sinking preventing member 60 may be tilted similarly to the first embodiment.

As an attachment order of the lumbar-sinking preventing member 60, a length of a portion into which the rear surface 65 is fit is cut out in a manner that the lumbar-sinking preventing member 60 is fit into the generally center part in the intermediate portion 17b of the lower frame 17, and then the cut surface and the lumbar-sinking preventing member 60 are jointed into an integral member. After that, the reclining shaft 11a is inserted through a hollow part of the lumbar-sinking preventing member 60 to assemble the seat frame F. In this case, only the lower frame 17 may be treated independently for the attachment of the lumbar-sinking preventing member 60, or the elongated portion 17a of the lower frame 17 may be anchored to the side frame 15 in advance and then the lumbar-sinking preventing member 60 may be attached thereto.

To the lumbar-sinking preventing member 60, the intermediate portion 17b of the lower frame 17 and the rear surface 65 is attached in a continuous manner. In other words, the lumbar-sinking preventing member 60 is welded to be jointed to the lower frame 17 by the rear contact portion 65b, which is an end of the rear surface 65. Further, the lateral size of the lumbar-sinking preventing member 60 is adjusted in a manner that the right and left end thereof may be disposed separated from the elongated portion 17a of both sides of the lower frame 17, respectively.

As illustrated in FIG. 11 and FIG. 12, the lumbar-sinking preventing member 60 is shaped into a hollow rectangular column having generally rectangular side surfaces. Further, as illustrated in FIG. 11, the rear surface 65 of the lumbar-sinking preventing member 60 is integrally anchor joined with the intermediate portion 17b of the lower frame 17. Although FIG. 11 and FIG. 12 illustrate an example in which the lumbar-sinking preventing member 60 is formed into a generally rectangular shape, the side surfaces thereof may be formed into a generally circular, generally ellipse shape, or the like as long as the side surfaces thereof are jointed with the lower frame 17 and do not abut against other components such as the reclining shaft 11a.

The lumbar-sinking preventing member 60 is formed by a plate metal having a predetermined thickness. In this case, the metal has a strength and hardness which may withstand the load upon rear end collision. Of course, the lumbar-sinking preventing member 60 may formed by other materials which may provide a preferable anchor joint with the lower frame 17 and have a strength that withstands the impact upon the vehicle rear side, that is, may formed by other materials having a strength which may withstand the load upon rear end collision.

The plate thickness, materials, or the like of the lumbar-sinking preventing member 60 may properly be selected to adjust the strength thereof. For example, the lumbar-sinking preventing member 60 with a thick plate may prevent the lumber sinking due to a sufficient strength of the lumbar-sinking preventing member 60, even in the case where the occupant's lumbar is caused to violently move rearward upon rear end collision.

Although this second embodiment employs a configuration in which the lumbar-sinking preventing member 60 formed into a hollow rectangular column is anchor joined with the cut surface of the lower frame 17, a configuration in which the rear surface 65 is anchor-joined with the intermediate portion 17b of the lower frame 17 in an overlapped manner without the cutting of the lower frame 17.

### Third Embodiment

A configuration of the lumbar-sinking preventing member 70 according to a third embodiment of the invention is described in detail below with reference to FIG. 13.

The lumbar-sinking preventing member 70 according to the third embodiment is formed by an upper surface 71, a lower surface 72, and a front surface 73 being split at the center part thereof, different from the lumbar-sinking preventing member 50 according to the first embodiment formed by the upper surface 51, the lower surface 52, the front surface 53 which are a continuous plate. Other configurations (a configuration of the movement member 30, for example) and operations than the lumbar-sinking preventing member 70 being split are the same as those in the first embodiment, and thus the description thereof is omitted.

According to the third embodiment, as illustrated in FIG. 13, the lumbar-sinking preventing member 70 includes a clearance portion 73a at the general center thereof. The clearance portion 73a is designed in a manner that a plate is absent in the vertical direction at the general center of the lumbar-sinking preventing member 70. For example, the clearance portion 73a is formed by splitting the lumbar-sinking preventing member 70. With this configuration, the spinal column of the occupant may enter the clearance portion 73a when the occupant's lumber is caused to sink rearward so that there is not a case where the spinal column abuts against the lumbar-sinking preventing member 70. As a result, even when the occupant's lumbar is caused to move rearward, that is, to move toward the lumbar-sinking preventing member 70, the load applied to the spinal column may be suppressed by the lumbar-sinking preventing member 70 and parts other than the clearance portion 73a may cause the occupant's upper body to tilt rearward.

Although the third embodiment illustrates a configuration of the lumbar-sinking preventing member 70 of which split portion is formed only at the generally center part, other configurations in which split portion(s) is additionally formed at the other location(s) may be employed as long as the generally center part is formed by a space. Increased number of splits may reduce a plate used to form the lumbar-sinking preventing member 70, and thus the weight of the seat back frame 1 may be reduced.

Although an example is described in which the generally center part of the lumbar-sinking preventing member 70 is split in the third embodiment, a configuration may be employed in which a part of the lumbar-sinking preventing member 70 in the vicinity of the location corresponding to the spinal column of the occupant is disposed rearward or in a recessed manner relative to the other parts to form the clearance portion. In other words, a configuration may be employed in which a recessed portion extends, on the upper surface 71 and the front surface 73, parallel to an edge end of the lumbar-sinking preventing member 70.

Further, a configuration may be employed in which a part in the vicinity of the location corresponding to the backbone of the occupant on the upper surface 71 and the front surface 73 is notched to form the clearance portion 73a.

### Fourth Embodiment

A configuration of a lumbar-sinking preventing member 80 according to the fourth embodiment is described in detail below with reference to FIG. 14.

The lumbar-sinking preventing member 80 according to the fourth embodiment is provided with a groove-shaped impact absorbing portion 81c which is formed on an upper surface 81, different from the lumbar-sinking preventing member 50 according to the first embodiment in which the upper surface 51 is formed by a smooth plate. Since a configuration and operations are similar to the lumbar-sinking preventing member 50 according to the first embodiment except for a configuration provided with the impact absorbing portion 81c, the descriptions thereof are omitted.

According to the fourth embodiment, the lumbar-sinking preventing member 80 is provided with the impact absorbing portion 81c formed by the upper surface 81 of which surface is partially recessed, as illustrated in FIG. 14. A groove (concave portion) is formed on the impact absorbing portion 81c to extend in a continuous manner in the lateral direction of the seat back frame 1 and generally parallel to a corner 84 or the reclining shaft 11a.

When the load from an occupant is applied to the lumbar-sinking preventing member 80 due to an impact equal to or more than a predetermined amount upon rear end collision, the impact absorbing portion 81c is deformed and the lumbar-sinking preventing member 80 is distorted, so that the impact absorbing portion 81c may absorb the impact. Although a configuration example in which the impact absorbing portion 81c is disposed only on the upper surface 81 is illustrated in the fourth embodiment, the impact absorbing portion 81c may be disposed on both the upper surface 81 and a lower surface 82 or may be disposed only on the lower surface 82.

It is preferable for the impact absorbing portion 81c to be formed only on the upper surface 81. This configuration enables a greater amount of tilting of a front surface 83 due to the deformation of the impact absorbing portion 81c upon rear end collision. In other words, the impact absorbing portion 81c is deformed, the lower part of the front surface 83 further extends forward, and then a greater amount of tilting thereof is achieved so that the movement which causes the occupant to tilt rearward is facilitated. As a result, the movement such that the occupant's upper body is caused to sink into the pressure receiving member 20 is induced.

Accordingly, since the plate configuring the impact absorbing portion 81c enables the deformation of the impact absorbing portion 81c when an excessive impact load is applied thereto, it is preferable for the plate configuring the impact absorbing portion 81c to be formed by a thinner plate than the plate configuring a surface other than the impact absorbing portion 81c (the upper surface 81).

The impact absorbing portion 81c formed by a plate having the equivalent thickness to that of the other surface (the upper surface 81) improves the rigidity to the lateral load. In other words, the groove-shaped (concave) impact absorbing portion 81c, which extends in the lateral direction and disposed on the lumbar-sinking preventing member 80, may receive the lateral load by its ridged part. Therefore, even if a large stress from the side is applied upon lateral collision or the like, the lumbar-sinking preventing member 80 receives the load, so that the space between the side frames 15 disposed in an opposed manner on both sides is ensured.

In the aforementioned first through fourth embodiments, illustrated are an example in which the side surface of the lumbar-sinking preventing member 50, 70, 80 are formed into a deformed generally squared U shape, respectively, and an example in which the side surface of the lumbar-sinking preventing member 60 is formed into a generally rectangular shape. However, a lumbar-sinking preventing member formed only by an upper surface portion (that is, formed by a single plate) may be employed as long as it is formed into a shape to be jointed with the lower frame 17 without any contact with other components such as the reclining shaft 11a. Further, the side surface may be formed into a rectangular shape, generally circular shape, or generally elliptical shape.

A configuration of which cross section has a generally squared U shape or rectangular shape like the lumbar-sinking preventing member 50, 60, 70, 80 has a structurally enhanced strength in the lateral direction compared to the lumbar-sinking preventing member formed only by the upper surface portion. As a result, a large amount of deformation resistance is achieved against the lateral stress upon lateral collision or the like, so that the deformation of the seat frame F is prevented.

Operations of the lumbar-sinking preventing members 50, 60, 70, 80 upon rear end collision are described below in detail with reference to FIGS. 15A-16B. FIG. 15A is an explanatory view of an occupant upon a normal state of seating according to a technique in the background art; FIG. 15B is an explanatory view of an occupant upon rear end collision in a state where the occupant seats himself/herself on a vehicle seat provided with the pressure receiving member and the link member according to a technique in the background art; FIG. 16A is an explanatory view of an occupant when the occupant normally seats himself/herself according to the first through fourth embodiment; and FIG. 16B is an explanatory view of an occupant upon rear end collision in a state where the occupant seats himself/herself on the vehicle seat S according to the first through fourth embodiment. Dotted lines in FIG. 15B and FIG. 16B represent the position of the occupant at a normal state. A thick solid line inside the seat back S1 in FIGS. 15A, B schematically represents the pressure receiving member 20. In FIGS. 16A, B, an upper thick solid line inside the seat back S1 schematically represents the pressure receiving member 20, and a lower thick solid line schematically represents the lumbar-sinking preventing member 50, 60, 70, 80 (more specifically, the front surface 53, 63, 73, 83).

As illustrated in FIG. 15A and FIG. 16A, an occupant seats himself/herself typically in a state where the back including the lumbar abuts against the seat back S1 on the vehicle seat S1 while seating. The direction of the load is typically applied on the rear part of the vehicle seat S as to a normal load upon seating.

When a large amount of impact is applied from the vehicle rear side, the impact load greater than the normal load upon seating pushes the upper body of the occupant forward, and then the head is suddenly caused to tilt rearward at a higher speed than the speed where the upper body lower than the shoulder (the torso) is caused to sink into the seat back S1. Accordingly, the cervical region is caused to tilt rearward along the base of the cervical region, that is, the coupling point of the cervical region and the torso as an axis. This causes the movement such that the cervical region to bend rearward (rear downward), and the cervical region is to receive a large amount of load.

For this kind of movement of the occupant, since the head is retained and stopped by the headrest S3 according to a technique as in FIG. 15B in which the upper body of the occupant is caused to sink rearward in a state where the posture while the occupant normally seats himself/herself is retained so that the head of the occupant abuts against the head rest; the rearward movement of the head is reduced. However, when the upper body of the occupant is caused to move rearward, it is desired to reliably and more rapidly support the head of the occupant by the headrest S3 by increasing the amount of the movement.

As illustrated in FIG. 16B, the vehicle seat S provided with the lumbar-sinking preventing members 50, 60, 70, 80 according to various embodiments of the present invention is configured to suppress and stop the rearward movement of the lumber and cause the occupant to sink rearward. According to the vehicle seat S having this configuration, the lumbar is pushed back by the lumbar-sinking preventing members 50, 60, 70, 80 when the upper body of the occupant is caused to sink rearward.

As a result, upon rear end collision, a relatively large sinking amount of the upper part of torso (the part in the vicinity of breast in the torso) of the occupant is achieved, the upper body is caused to tilt rearward (to pivot rearward around the vicinity of buttock), and then the cervical region and the head are caused to move rearward together with the upper body. As a result, it is possible to reliably cause the upper part of the occupant's torso to tilt rearward with a sufficient amount of movement (relative movement amount of the upper part of the torso to the lumber), so that the head is reliably supported by the headrest S3.

The term “the upper part of the torso” preferably refers to the position corresponding to the breast region, and it is preferable for this part to sink toward the seat back S1. Specifically, “the breast region” refers to the first thoracic vertebra through the sixth thoracic vertebra of the occupant, and it is more preferable for the fourth thoracic vertebra to sink rearmost.

As described above, according to various embodiments of the present invention, disposing the lumbar-sinking preventing member 50, 60, 70, and 80 enables increasing a relative amount of rearward movement of the upper part in torso to that of the lower part in torso. Accordingly, it is possible to reliably and efficiently cause the upper part of torso to sink into the seat back S1 so that the effect for reducing the impact onto the cervical region is further improved.

The cervical region load reduction element is a movement amount suppression member which is disposed rearward the occupant's lumber for suppressing the rearward movement of the lumber. This configuration which retains and stops the lumbar enables a stable support of the lumber and thus an improved effect for reducing the load on the cervical region.

In the aforementioned embodiments are described related to the seat back S1 which is a front seat of an automobile as specific examples. However, such a configuration may be applied to a seat back of a rear seat without being limited to those.

TABLE OF REFERENCE NUMERALS

| | | |
|---|---|---|
| S | | vehicle seat |
| S1 | | seat back |
| S2 | | seat base |
| S3 | | headrest |
| F | | seat frame |
| 1 | | seat back frame |
| 2 | | seat base frame |
| | 1a, 2a, | cushion pad (pad material) |
| | 3a | |
| | 1b, 2b, | outer layer material |
| | 3b | |
| 11 | | reclining mechanism |
| | 11a | reclining shaft |
| 15 | | side frame |
| | 15a | side plate |
| | 15b | front edge |
| | 15c | rear edge |
| | 15d | protrusion portion |
| | 15e | convex portion |
| | 15f | slope portion |
| | 15g | stopper portion |
| | 15h | hole portion |
| | 15i | planar portion |
| 16 | | upper frame |
| | 16a | side surface portion |
| 17 | | lower frame |
| | 17a | elongated portion |
| | 17b | intermediate portion |
| 18 | | pillar support portion |
| 19 | | headrest pillar |
| 20 | | pressure receiving member |
| 21 | | wire (coupling member, upper coupling member) |
| 22 | | wire (coupling member, lower coupling member) |
| | 22a | hook portion (hook end) |
| 30 | | movement member (impact reduction member) |
| | 30a | base portion |
| | 30b | first raised portion |
| | 30c | formation portion |
| | 30d | second raised portion |
| 31 | | locking portion |
| | 31a | locking concave portion |
| 32 | | shaft |
| | 32a | shaft member |
| | 32b | shaft hole |
| | 32c | hole portion |
| | 32d | fitting member |
| 33 | | locking hole |
| 34 | | pivoting suppression portion |
| 35 | | tension coil spring (biasing element) |
| | 35a | hook |
| 37 | | shaft supporting member |
| 38 | | protruded piece |
| 39 | | movement preventing portion |
| 50, 60, | | lumbar-sinking preventing member (cervical region load |
| 70, 80 | | reduction element) |
| 51, 61, | | upper surface |
| 71, 81 | | |
| | 51a | upper contact portion |
| | 81c | impact absorbing portion |
| 52, 62, | | lower surface |
| 72, 82 | | |
| | 52a | lower contact portion |
| 53, 63, | | front surface |
| 73, 83 | | |
| | 73a | clearance portion |
| 54, 64, | | corner |
| 74, 84 | | |
| 65 | | rear surface |
| | 65a | edge end |
| | 65b | rear contact portion |

1. A vehicle seat comprising:
a seat back frame including side frames located on sides thereof;
a pressure receiving member coupled to the seat back frame via coupling members to support an occupant; and
an impact reduction member disposed on at least one of the side frames and coupled to the coupling members to cause the pressure receiving member to move rearward by a predetermined amount when an impact load is applied to the pressure receiving member;
the seat back frame further including a lumbar-sinking preventing member which prevents movement of a lumbar of the occupant from sinking rearward.

2. The vehicle seat according to claim 1, wherein:
at least a part of the lumbar-sinking preventing member is disposed forward relative to a front end of the pressure receiving member.

3. The vehicle seat according to claim 1, wherein:
at least a part of the lumbar-sinking preventing member is disposed forward relative to at least a part of the impact reduction member.

4. The vehicle seat according to claim 1, wherein:
the pressure receiving member is coupled to the seat back frame via an upper coupling member locked to an upper part thereof and a lower coupling member locked to a lower part thereof;
the upper coupling member and the lower coupling member are formed by a flexible wire respectively; and
the wire configuring the upper coupling member is formed thinner than the wire configuring the lower coupling member.

5. The vehicle seat according to claim 4, wherein:
the impact reduction member is coupled to the lower coupling member.

6. The vehicle seat according to claim 4, wherein:
the lumbar-sinking preventing member comprises a front surface disposed in a forward direction; and
at least a part of the front surface is disposed forward relative to a front end portion of the lower coupling member.

7. The vehicle seat according to claim 1, wherein:
the lumbar-sinking preventing member is disposed rearward relative to a front end of the side frame.

8. The vehicle seat according to claim 1, wherein:
the lumbar-sinking preventing member comprises a front surface disposed in a forward direction; and
a lower part of the front surface is bulged forward relative to an upper part.

9. The vehicle seat according to claim 8, wherein:
the front surface of the lumbar-sinking preventing member is tilted at a generally same angle as a front surface of the pressure receiving member.

10. The vehicle seat according to claim 1, wherein:
a corner formed at an interface between an upper surface and a front surface of the lumbar-sinking preventing member is formed in a smooth bulged-curved shape bulging upward.

11. The vehicle seat according to claim 1, wherein:
at least a part of the lumbar-sinking preventing member is disposed forward relative to the shaft of the impact reduction member.
